(19) United States
(12) Patent Application Publication
(10) Pub. No.: US 2015/0254773 A1
(43) Pub. Date: Sep. 10, 2015

(54) SPECIFICATION HANDLING SYSTEM

(71) Applicants: Sean Henry Drake, Cambridge, MA (US); Rajpal Rathor, Ilford (GB)

(72) Inventors: Sean Henry Drake, Cambridge, MA (US); Rajpal Rathor, Ilford (GB)

(21) Appl. No.: 14/660,101

(22) Filed: Mar. 17, 2015

Related U.S. Application Data
(63) Continuation of application No. PCT/IB2015/000329, filed on Mar. 4, 2015.
(60) Provisional application No. 61/947,773, filed on Mar. 4, 2014.

(51) Int. Cl. G06Q 40/04; G06F 17/30

(52) U.S. Cl. CPC G06Q 40/04; G06F 17/30864; G06F 17/30171

(57) ABSTRACT

A deal management system is described which comprises a database storing first users' sell specifications and second users' buy specifications. Each sell specification comprises a locked portion and a non-locked portion of data. A matching module searches the non-locked portions using a searching specification, and a networking module sends an unlock request to a first user associated with a matching sell specification and provides the locked portion to a second user associated with the matched searching specification in response to receiving an unlock permission from the first user. A flow management module manages tasks associated with a specification acceptance process, and is responsive to a positive selection of a matched specification by a first user and a second user, and provides a graphical user interface for managing the tasks until the first and second users accept each other's buy and sell specifications and a deal regarding those specifications is completed.

### CROSS-REFERENCE TO RELATED APPLICATIONS

This application is a continuation of International Application No. PCT/IB2015/000329, filed Mar. 4, 2015, which claims the benefit of U.S. Provisional Application No. 61/947,773, filed Mar. 4, 2014, all of which are incorporated herein by reference.

### TECHNICAL FIELD

The present disclosure concerns a specification handling system and more particularly, though not exclusively, is directed to a system and method of matching transaction counterparties and managing transactions for use in the mergers and acquisitions field. The matching of counterparties which have complementary requirements without revealing the details of the requirements of a selling party can advantageously result in a more varied pool of potential counterparty pairs. The seamless integration of the management of a transaction with the process of matching of counterparties advantageously increases the speed and success rate of transaction completion and also minimizes the risk of errors.

### BACKGROUND

Buyers and Sellers in the field of Mergers and Acquisitions (M&A) need to find qualified and relevant counterparties to conduct business efficiently. However, in the global space, it can take a considerable amount of time, resources and energy to source and match deals. Firms are spending unnecessary time and money deal sourcing and matching. Ernst and Young recently reported the average time for deal completion within M&A has risen to 52 days; this is a significant increase from previous years. In addition to this, the deal completion rates are down to 62% down from 67% the previous year. This all indicates that the environment is becoming increasingly difficult to find and source deals. This causes immense problems for M&A firms (especially boutiques) as it slows down the cash flow within the business. In addition, a current issue with the status quo is that smaller companies or corporations within the emerging marketing may not have the time, money and resources. This results in potential clients being unable to attract, maintain and reach a global audience for investment purposes.

Within this field computer based systems have been developed to assist parts of the process of searching for a buyer and searching for a seller. These are often crude systems which often are limited in their scope because they are subscribed to just a subset of the possible counter parties. Other system exist for matching buyer and sellers, but these are simply search engines which carry out parameter matching and then provide the matched results to the users for management of the matched deal to completion. The difficulty with these systems is that they are not trusted by the users as the data is often very sensitive and sellers are wary of disclosing sensitive information about offering assets or companies for sale. The massive amount of due diligence which is required presents a management burden which slows down the process to completion.

### SUMMARY

Embodiments of the present invention provides a system which facilitates M&A activity (sourcing and matching deals) on a global scale and incorporates a deal management system such that the process can be managed to completion in an efficient manner. This type of integration of deal management into deal matching saves members precious time and resources by allowing them to streamline the M&A process and information flow to complete deals. The present invention's unique solution also provides global support for all stakeholders involved within the deal making process.

Deal matching and deal managing are issues that have not been addressed in an integrated efficient manner before. A system embodying the present invention described herein provides a one-stop solution for the trends arising in M&A. The system fills the void in the M&A space for a complete system for effective sourcing, matching and management of deals. All of this is provided in the described embodiments/manner which is consistent with maintaining control over anonymity of at least one of the parties to the deal.

### BRIEF DESCRIPTION OF THE DRAWINGS

FIG. 1 is a schematic block diagram illustrating elements of a system for sourcing, matching and managing a transaction in accordance with an embodiment of the present invention;

FIG. 2 is a schematic block diagram illustrating elements of a data store in accordance with an embodiment of the present invention.

FIG. 3 is a flow chart illustrating an overview of the method of sourcing and matching counterparties of a transaction initiated by a seller party in accordance with an embodiment of the present invention;

FIG. 4 is an exemplary illustration of a seller transaction specification according to the method of FIG. 3;

FIG. 5 is an exemplary illustration of a results list according to the method of FIG. 3;

FIG. 6 is a flow chart illustrating an overview of the method of sourcing and matching counterparties of a transaction initiated by a buyer party in accordance with an embodiment of the present invention;

FIG. 7 is an exemplary illustration of a buyer specification according to the method of FIG. 6;

FIG. 8 is a schematic block diagram illustrating the elements comprising a transaction matching module 3 of the system of FIG. 1;

FIG. 9 is an exemplary illustration of an interface provided by a user management module of the transaction matching module of FIG. 8;

FIG. 10 is an exemplary illustration of an interface provided by a user management module of the transaction matching module of FIG. 8;

FIG. 11 is a flowchart illustrating a method of transaction sourcing initiated by a seller in accordance with an embodiment of the present invention;

FIG. 12 is an exemplary illustration of a limited seller specification according to the method of FIG. 11;

FIG. 13 is an exemplary illustration of an optional unlocking form in accordance with the method of FIG. 11;

FIG. 14 is a flowchart illustrating a method of transaction sourcing initiated by a buyer in accordance with an embodiment of the present invention;

FIG. 15 is an exemplary illustration of a limited buyer specification according to the method of FIG. 14;

FIG. 16 is an exemplary illustration of an unlocking form according to the method of FIG. 14;

FIG. 17 is a schematic block diagram illustrating elements of the transaction flow management module of the system of FIG. 1;

FIG. 18 is an exemplary illustration of task and staff user assignment according to an embodiment of the invention;

FIG. 19 is an exemplary illustration of a notification interface provided by the notification module of FIG. 17;

FIG. 20 is an exemplary illustration of the interface provided by the overview module of FIG. 17;

FIG. 21 is an exemplary illustration of the interface provided by the overview module of FIG. 17;

FIGS. 22a and 22b are a flowchart illustrating a transaction flow management method according to an embodiment of the present invention; and

FIG. 23 is a flowchart illustrating an offline transaction matching process according to an embodiment of the present invention.

### DETAILED DESCRIPTION

A system and method for providing functionality that enables a specification handling system such as a deal management system to be implemented is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. For example, the invention is described in one embodiment below with reference to user interfaces and particular hardware. However, the invention applies to any type of computing device that can receive a data and commands, and any peripheral devices providing services.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

An overview of the operation of a system embodying the present invention is now provided followed by a detailed description of exemplary embodiments of the present invention.

The present embodiments are related to an online deal matching and deal management system for the high growth M&A market. It is the first system to integrate deal sourcing, deal matching and a complete deal flow management tool within one system. The deal sourcing and matching module (‘deal matching module’) allows members to find buyers and sellers from an accredited global customer base in which they could facilitate a deal. Members input their deal requirements. The system then instantly matches each member with a relevant counterparty from a global member database—a buyer or a seller, depending on the member's request. For example, a member may be looking to sell some assets on behalf of a client. The member adds the business assets they are interested in selling to their member profile. Following that, relevant buyers from the global customer database are notified based on deal criteria they have previously specified. For example, a seller listing a national airline for sale has his deal matched with buyers who have selected airlines as an industry of interest for notification.

Industry type is not the only filter that can be applied to a match: deal size; geographical location and deal types are further criteria which members can specify to find a suitable match. If a counterparty is not found instantly, the member will receive a notification as soon as a relevant counterparty is matched.

This process saves time, money and resources for clients by generating a target list of potential counterparties. The process also exposes the members to a global database of professionals and this allows members to expand their business networks; they will be in contact with new professionals who otherwise they may not have been exposed to. However, in keeping with the traditional non-computerized aspects of M&A, the members remain anonymous. The M&A space has its various traditions which the system embraces, whilst also leveraging technology to help professionals get deals matched and completed as soon as possible.

To complement this, the system also provides a deal management module (‘deal flow management module’), which allows members to maintain and track the progression of their deals at one source. The primary aim of the deal flow management module is to centralize all the information needed by all users to drive deals forward quickly. The deal flow management module provides an extensive list of features created to help M&A professionals to manage deals effectively and to complete deals in a timely manner in any location. It provides the following functionalities:
Deal Management—allowing management of all deals from a task, time and cost perspective. This provides an overview of each deal and furthermore an overview analysis of the member's current portfolio. Members are able to post, match, subscribe/track and manage deals securely. An additional feature of this is that it allows members to manage deals online using the system's tools even if those deals were originally sourced and matched offline without using the system.
Member Management—Members can ‘add’ other staff users to deal management tool. This allows deal-specific tasks to be assigned to and tracked by staff users. The users have flexibility over the permissions of each staff member, for added security. Deals have a dedicated drive for documents to be uploaded and edited by authorized staff. An admin interface is provided where all user accounts are managed for example checking payments, adding and removing of accounts, monitoring user search patterns and behaviors etc.
Deal Reporting—a comprehensive reporting solution is provided.
Smart Event Calendar—event calendar that shows outstanding invoices, deals and tasks based on current/selected month/year. Linked to ‘Payment/invoice management’.
Database Backup/Restore facility—built in backup/restore feature for backing up and restoring an entire database.

The primary aim of the deal flow management module is to centralize all the information needed by all members to drive deals forward faster.

Furthermore, the system provides a secure and controlled environment for deal matching and management. The system's quality is directly linked to its pool of members in the accredited global customer database. It is ensured that the matching members are verified in order to maintain the validity of buyer side and seller side mandates. This supports the integrity of the system. The system connects members to a global database of M&A professionals. This allows members to match with previously unknown counterparties. This process expands the members' professional networks and the probability of sourcing a desirable counterparty for their deal.

The network is a multilingual environment and to cater to the online audience, the system form is available in the most prominent languages. This ensures a global audience for deals from all over the world.

The system provides a localized system with a global reach—giving qualified members a local experience whilst access to a global pool of opportunities. In addition to this, it is one of the few M&A systems that are truly mobile ready. Members can take full advantage of the deal management and matching tools whilst on the go. Whether it would be matching deals or assigning tasks throughout the deal management system, members are able to drive your deals forward on the go. Some of the notable benefits of the system (and not limited there to) are as follows:
Allows clients to source and match deals instantly saving time and money.
Allows the deal flow management system to provide members with all the information needed in a central location to drive deals forwards and driving efficiency
Allows members to add staff to the system to aid the progression of deals using the task management tool.
Allows members to manage deals which they have matched offline, this helps in having all their portfolio being managed in one place
Allows members to have an internal deal drive with their associates and colleagues for the efficient flow of data.
Allows members to have a drive with their counterparty so that documents can be exchanged.
Analyses the M&A market using market traffic tools.
The system can be translated into various languages to provide a local experience.

The system also provides a secondary service within the system that provides certain M&A clubs, investment organizations and government trade bodies to have their own customized system. These clubs and organizations can have anywhere from 50-1000 members.

This ‘white label’ service provides these communities a system with an appearance of their choice where they can conduct M&A activity. The appearance is customized to the organization, with their logo and colors. They can match deals between their own communities, with all the existing functions that the system provides, however they have the option to open their deal to the whole global customer database if they wish. This is a unique service offered by the present system.

Embodiments of the present invention are now described in detail.

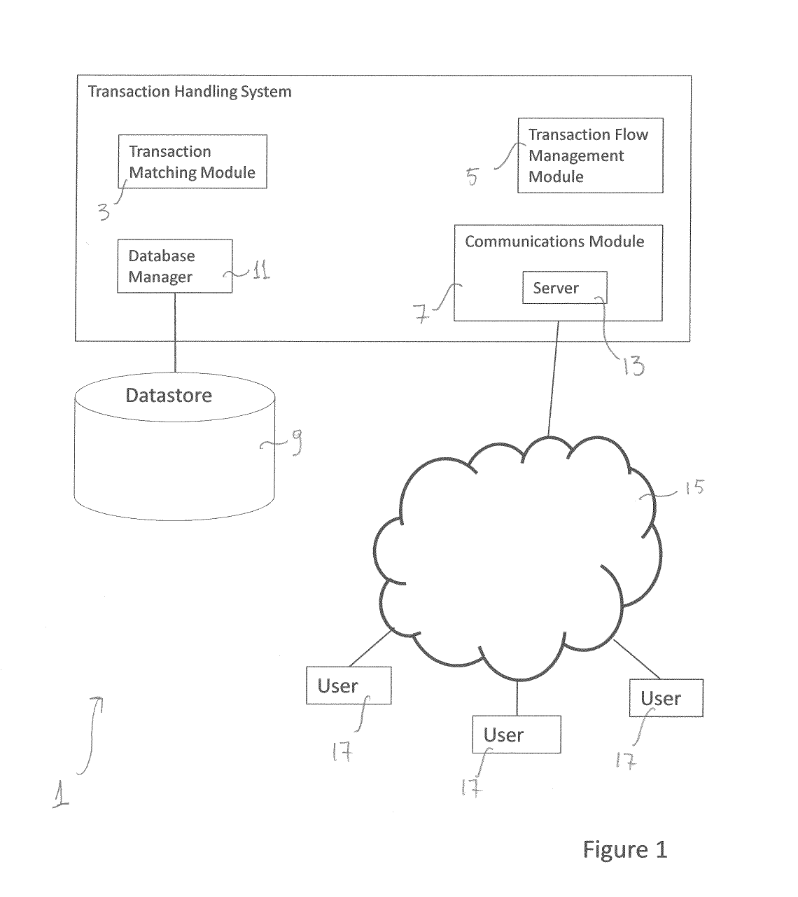

The overall architecture of a transaction matching and managing system 1 (a specification handling system) embodying the present invention is now described referring to FIG. 1. The transaction matching and managing system comprises a transaction matching module 3, a transaction flow management module 5, a communications module 7, a datastore 9, a database manager 11 and a server 13. The system 1 can communicate with several users via an external communications network 15 such as the World Wide Web.

Each user 17 is a microprocessor-controlled device (for example a Personal Computer, a laptop computer, a mobile smart phone or a tablet computer) which is configured to run a piece of software that accesses the service made available by the system on behalf of a party which wishes to sell or purchase assets, a seller or buyer respectively. In some embodiments the software or firmware can be a browser functionality or program such as Google Chrome® or Microsoft Internet Explorer®.

The service of the system is, in some embodiments, made available to the users by means of HTML pages served by a server 13 operatively connected to the external communications network 15, as well as the system's datastore 9 and all of the system's logical subunits. Each of the system's logical subunits as shown in FIG. 1 are embodied in processor-controlled modules.

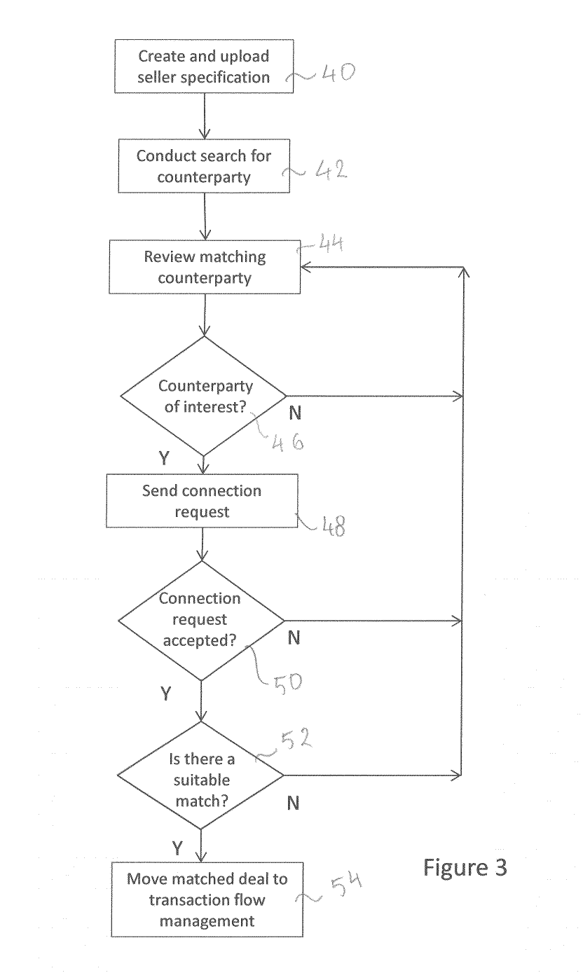

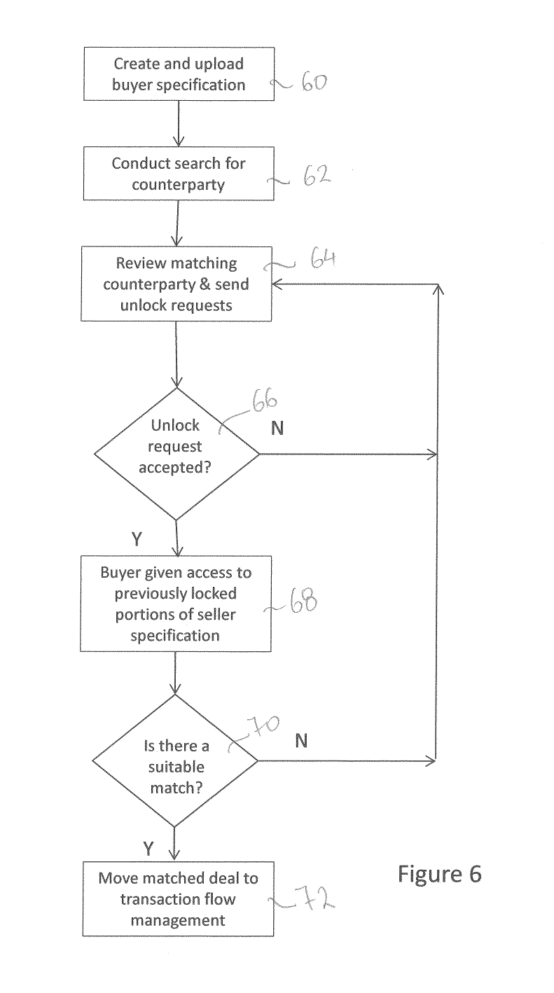

The transaction matching module 3 is a logical subunit of the system 1 which carries out functions relating to transaction matching. These functions include but are not limited to setting up user (buyer or seller) profiles, creating and uploading transaction specifications (buyer or seller specifications) and matching buyer and seller search specifications. The matching module 3 also serves to find willing counterparties to a transaction by getting approval for further progression of matched specifications, hopefully to a stage where they can be completed. The functions performed by the transaction matching subunit also relate to transaction sourcing, including but not limited to conducting searches of the specifications stored in the database, as will be described below, with reference to FIGS. 3 and 6. These searches enable users to browse the searchable portions of specifications stored in the database and help to establish user interest in deals which may have been added since their last search.

The transaction flow management module 5 is a logical subunit of the system which carries out functions relating to managing transactions from the point when a matched buyer and seller agree to go through with a transaction, until that transaction is completed. These functions include managing tasks which need to be carried out, monitoring progress of the transaction to completion and facilitating access to information specific to the transaction which is necessary for all authorized persons to have access to complete their tasks. The functions performed by the transaction flow management module 5 will be described in more detail with reference to Figure Y.

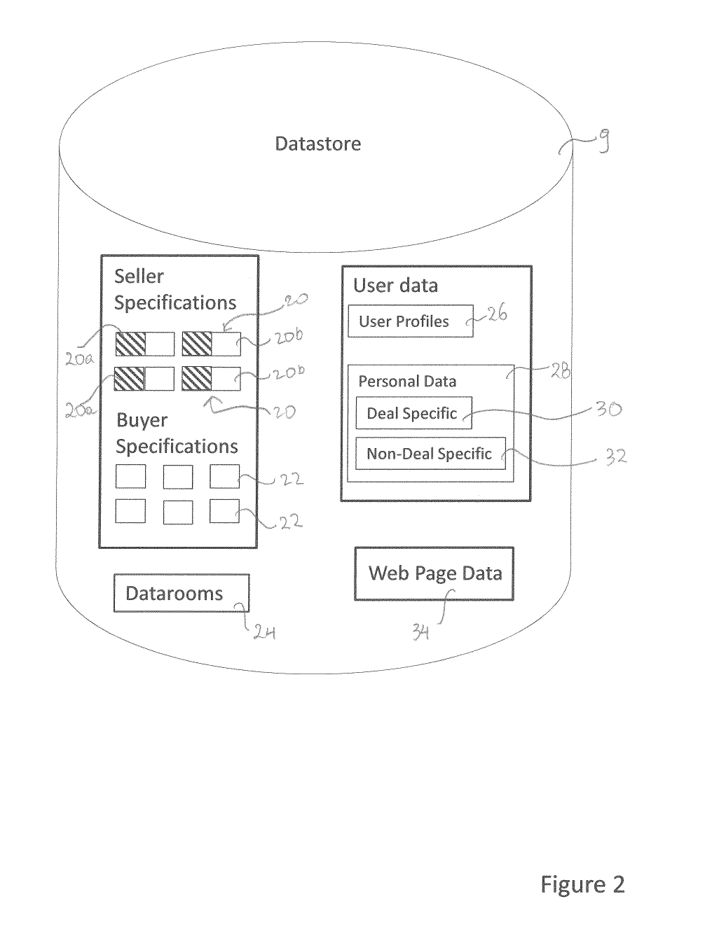

The database manager 11 module is operatively connected with all the subunits of the system and manages all data storage to and retrieval of data from the data store. The datastore 9 stores several different types of data as will be described in detail later. However, one key type of component which is stored is buy and sell specifications. The data store will be described in more detail with reference to FIG. 2.

The communications module 7 handles all communications to and from the deal management system 1 typically from users 17. The communications module 7 also comprises a website server 13 which functions to server 13 web pages to user devices which access those pages via local internet browsers. In this way the server 13 provides support for a graphical user interface which is provided to each user of all of the activity related to them which is currently being handled by the system.

Referring now to FIG. 2, there is shown in a schematic form some of the types of data stored in the datastore 9. The key data stored is buyer specifications and seller specifications. These are specifications uploaded by the users who act as sellers or buyers. The seller specifications 20 each have two distinct portions, a locked portion 20a and an non-locked portion 20b (non-locked portion 20b). The locked portion 20a is not visible (and therefore cannot even be searched) without specific unlocking by the owner of the specification. The non-locked portion 20b gives general details of the deal being sought to be sold but does not give the user's identity away. The buyer specifications 22 are simply provided as a single non-locked portion which can readily be searched as required. The locked portions may also comprise a subset of key locked data in the form of a summary which is termed a ‘teaser’.

The datastore 9 also comprises a plurality of datarooms 24 which are areas reserved for a set of documents relating to a matched pair of buyer and seller specifications. The datarooms 24 are deal specific and provide areas for secure storage of documents and information which is to be shared between parties which are the subject of the potential deal. A key feature of the datarooms 24 is that they each need to be set up with a set of permissions as to who can access the data in the specific data room to read the same and who can add data to the data room for sharing with other authorized personnel.

The datastore 9 also stores user data which can be used by the system to support deal flow management. More specifically, the user data comprises user profiles 26 which specify the people who are associated with the user organization and what access permissions they have to the user organization data. The user data also comprises personal data 28 which is personal to the user. This personal data 28 can be deal specific data 30 as well as non-deal specific data 32. It is to be appreciated that the data rooms 24 are populated by a subset of the deal-specific data 30 and a subset of the non-deal specific data 32.

The data store 9 also stores supporting web page data 34 for use by the communications module 7 in serving web pages to requesting users 17 (sometimes referred to as members elsewhere).

A functional overview of how a seller-side deal matching process is carried out using the above system is now described.

A party (user) interested in selling an asset (‘seller’) firstly creates, at Step 40, a transaction specification (seller specification 20) and uploads the specification to the system. To set up the seller specification 20, the seller inputs various parameters relating to the transaction they wish to carry out and the desired buyer they wish to work with. A subset of these parameters constitutes the open (non-lockable) seller search specification 20b which is used to match the seller specification with appropriate buyer specifications. Accordingly, the each seller specification 20 is logically divided in two parts—the seller search specification 20b (non-locked part of the specification) which is available to the search engines of the system (namely search engines provided in both the transaction matching module 3 and the transaction sourcing module), and locked seller specification (locked portion 20a), which is not accessible by the search engines until it is non-locked by the seller.

Parameters which are included in the seller search specification in this embodiment may include:
Deal Title *—(This is the name of the deal and for the user's personal use)
Headliner *—(This would be the one liner to describe the deal, this will be used primarily in matching)
Expiry Date *—(expiry date of the deal) Transaction type* (Buyout/company sale); (Management buyout); (Majority recapitalization); (Minority recapitalization); (Asset sale growth capital); (Senior debt); (Junior/mezzanine debt); (Joint venture/partner); (Distressed situation)
Industry Classification*
Domicile*—(geographical region—the area) the asset is in
Desired sponsor* (Private Equity Group Venture Capitalist Investment Bank Corporate M&A Dept Family Office Lender)
Deal Size* 1 m-10 m; 11 m-50 m; 51 m-100 m; 101-250 m; 251-500 m; 500 m+
Revenue* 0.25 m-0.5 m; 0.51-1 m; 1.1 m-10 m; 11 m-50 m; 51 m-100 m; 101-250 m; 251-500 m; 500 m+
EBITA* (Earnings Before Interest, Tax, and Amortization)
<0; 0-2.5 m; 2.51-5 m; 5.1 m-10 m; 11 m-20 m; 20 m-50 m; 51 m-100 m; 100 m+
Currency * USD (default); EUR; GBP
Teaser* (This is a document a Currency * USD (default); EUR; GBP
Teaser* (This is a document a seller can opt to upload. The purpose of this document is to provide a more detailed overview of the transaction than the overview presented in the seller search specification)
Exclusive Representation* (Yes or No)

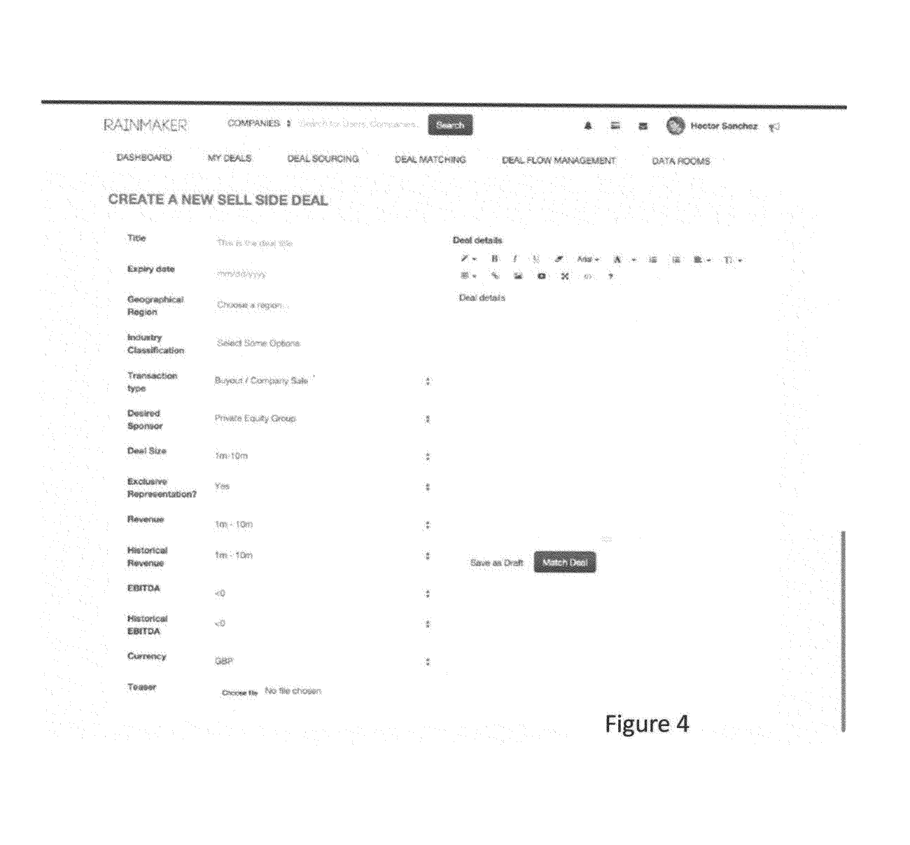

An overview of the graphical user interface in accordance with an embodiment of the invention which allows a seller to input the seller search specification parameters can be seen in FIG. 4.

A process of matching a seller specification with existing buyer specifications is now described with reference to FIG. 3. After completing, uploading and saving the seller specification at Step 40, the seller can choose to activate a search, at Step 42, for suitable buyers. The seller may choose to do so immediately, or save the seller search specification and conduct the search later. In another embodiment the uploading automatically triggers a search for suitable users.

The seller then receives, at Step 44, a list of buyer specifications (‘results’ from the transaction matching module 3 conducting a search of the buyer specifications 22 stored in the data store 9) that match the requirements set out on the seller search specification 20.

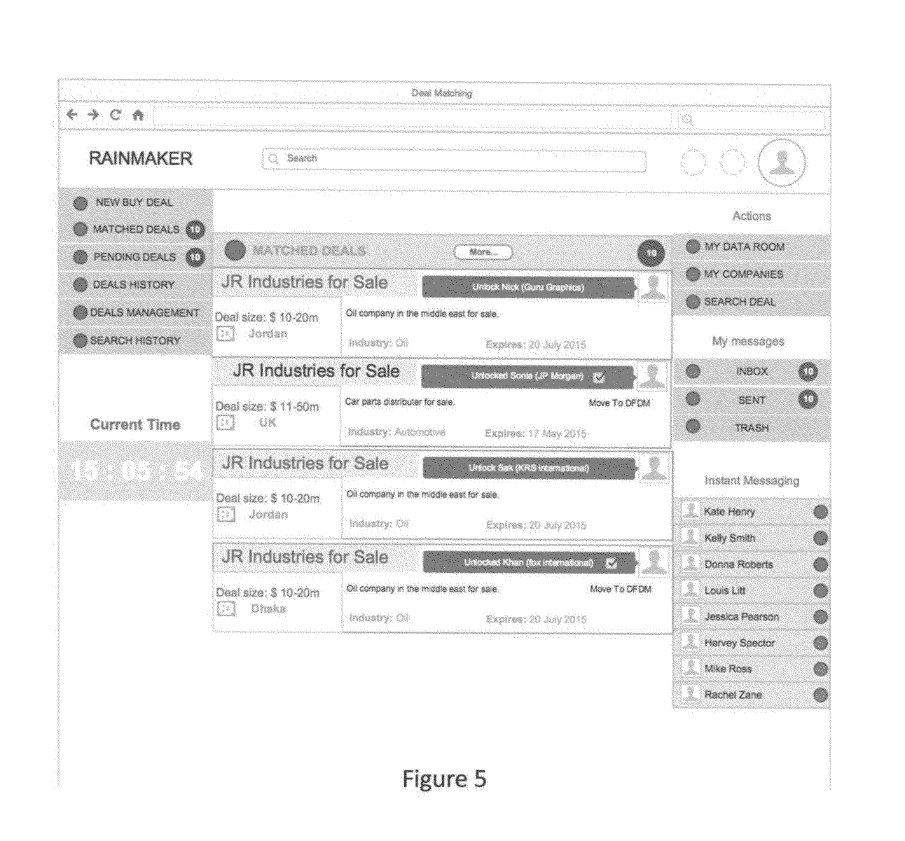

An overview of the graphical user interface in accordance with an embodiment of the present invention which allows a seller to review their results list can be seen in FIG. 5.

For each buyer on the results list, the seller is able to review the parameters included in the buyer search specification. These parameters may include:
Headliner
User Profile (navigate in and out of their profile and back to the results page, but no access to contact information)
Company Profile (navigate in and out of the company page, and back to the results page)
Industry classification of the deal matched
Expiry Date
Size
Domicile
Deal Size
Revenue
Desired Sponsor
Transaction Type
Teaser

The seller selects the buyers he likes and sends a connect request together with an unlock of their specification. I the buyer

The seller then reviews, at Step 44, each matched buyer search specification on the results set individually.

The seller then examines, at Step 46, whether a buyer is of interest.

If it is determined, at Step 46, that the buyer is of interest, the seller may send, at Step 48, the buyer a connection request.

If it is determined, at Step 46, that the buyer is not of interest, then the seller continues reviewing matched buyers at Step 44.

After a connection request has been sent at Step 48, it is examined, at Step 50 whether the connection request has been accepted by the buyer.

If it is determined, at Step 50, that the connection request has not been accepted, the seller returns to the reviewing step 44.

If it is determined, at Step 50 that the connection request has been accepted by the buyer, then a temporary communications channel, such as an instant messaging channel, between the two parties is set up and the locked part of the seller specification becomes visible to the buyer at Step 52.

It should be noted that once the search has been activated at Step 42 it runs continuously until the seller has completed a transaction. As a result, every time a buyer specification 22 is added to the system 1 or an existing buyer specification is modified such that if the buyer search specification now matches the seller search specification, the newly matching buyer search specification is added to the results list and the seller is notified.

Unless one of the parties then indicates at Step 52 that they do not wish to proceed with the transaction, the transaction is subsequently ‘matched’ and moved, at Step 54 to transaction flow management (‘deal flow management’).

It should be noted that a transaction moving to deal flow management does not trigger a halt of the search for matching counterparty (buy-side) specifications, at Step 54. On the contrary, the search continues to run and the seller may continue reviewing prospective buyers of the results set until a transaction has been completed or until the date of expiry of the search has been reached, whichever is earlier.

In addition to this, the seller can also move on to the deal flow management stage with as many buyers as they wish.

The exemplary graphical user interface of FIG. 5 illustrates a results list in which the transactions with more than one buyer have already been moved to transaction flow management.

A functional overview of how a buyer-side deal matching process is carried out using the above system is now described with reference to FIG. 6. A party interested in buying an asset (‘buyer’) firstly creates, at Step 60, a transaction specification (buyer specification 22) and uploads, at Step 60, the specification to the system. To set up the buyer specification 22, the buyer inputs various parameters relating to the transaction and the desired seller specification.

Parameters which are included in the buyer search specification in this embodiment may include:
Deal Title *—(This is the name of the deal and for your personal use)
Headliner *—(This would be the one liner to describe the deal, this will be used primarily in matching)
Expiry Date *—(expiry date of the deal)
Transaction type* (Buyout/company sale); (Management buyout); (Majority recapitalization); (Minority recapitalization); (Asset sale growth capital); (Senior debt); (Junior/mezzanine debt); (Joint venture/partner); (Distressed situation) Industry Classification*
Domicile*—(geographical region) the area asset is in
Deal Size* 1 m-10 m; 11 m-50 m; 51 m-100 m; 101-250 m; 251-500 m; 500 m+(more than one field boundaries may be selected)
Revenue* 0.25 m-0.5 m; 0.51-1 m; 1.1 m-10 m; 11 m-50 m; 51 m-100 m; 101-250 m; 251-500 m; 500 m+
EBITA* (Earnings Before Interest, Tax, and Amortization)
<0; 0-2.5 m; 2.51-5 m; 5.1 m-10 m; 11 m-20 m; 20 m-50 m; 51 m-100 m; 100 m+
Teaser buyer can opt to upload. The purpose of this document is to provide a more detailed overview of the transaction than the overview presented in the buyer search specification)
Exclusive Representation* (Yes or No)

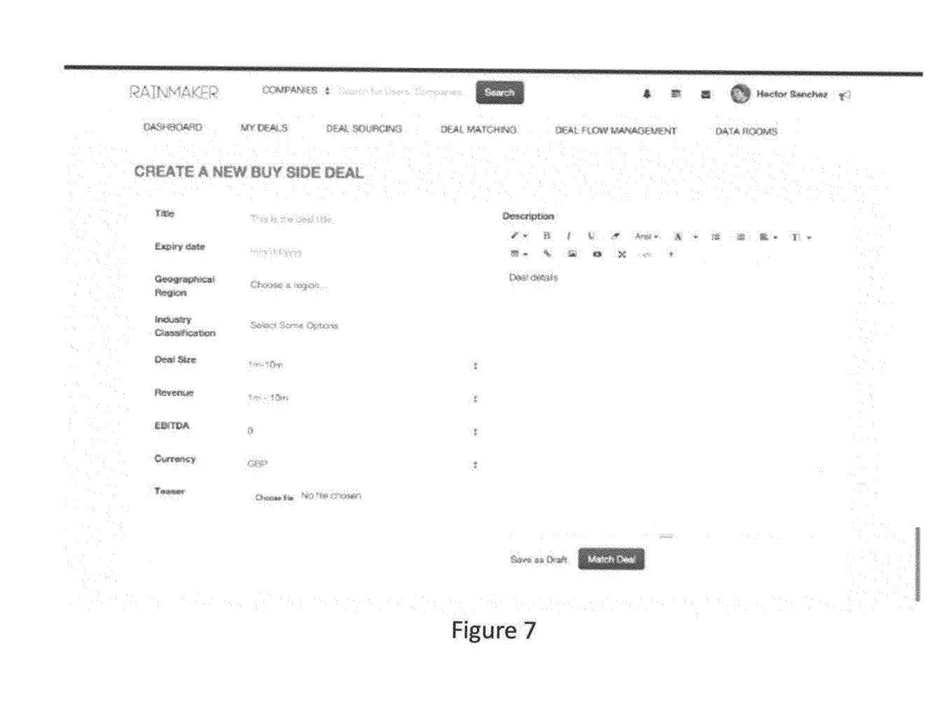

An overview of the graphical user interface of an embodiment of the invention which allows a buyer to input the buyer search specification parameters can be seen in FIG. 7.

After completing uploading and saving the buyer specification, the seller can choose to activate, at Step 62, a search for suitable sellers. The buyer may choose to do so immediately, or save the buyer search specification and conduct the search later. In another embodiment the uploading automatically triggers a search for suitable sellers.

The buyer then receives, at Step 64, a list of seller search specifications 20a (‘results’) that match the requirements set out on the buyer's buyer search specification.

It should be noted that once the search has been activated at Step 62 it runs continuously until the buyer has completed a transaction. As a result, every time a seller specification is added to the system or modified such that it fits the buyer specification, the newly matching seller specification is added to the results list and the seller is notified.

The results list is presented, at Step 64, to the buyer in the GUI generated by the server 13. For each seller on the results list, the buyer cannot initially view the full details of the seller until the seller has given their permission (accepted the unlock request). Until the unlock request has been accepted, the buyer can only view the seller search specification 20a, which may in one embodiment contain the following information:
Headliner
Industry classification of the deal matched
Expiry Date
Status of matched deal—Request for unlock/Deal Pending/Deal Matched
Deal Size
Transaction Type
Teaser

For each individual seller specification of the result set, the buyer chooses whether they are interested in the advertised transaction and wish to find out more by sending, at Step 64, an unlocking request.

If it is determined, at Step 66, that the unlock request is rejected by the seller, the seller specification 20b is removed from the results set and the buyer reviews the next seller specification in the result set.

If it is determined, at Step 66, that the unlock request is accepted, the transaction becomes pending and the buyer is given access, at Step 68, to the entire seller specification 20. Unless it is determined, at Step 70, that one of the parties then indicates that they do not wish to proceed with the transaction, the transaction is then ‘matched’ at Step 72 and moved to transaction flow management (‘deal flow management’).

It should be noted that a transaction moving to deal flow management does not trigger a stop of the search for matching counterparty (sell-side) specifications. On the contrary, the search continues to run and the buyer may continue reviewing the prospective sellers of the results set and can move on to the deal flow management stage with as many sellers as they wish. The search can continue to run and the buyer may continue reviewing different sellers of the results set until a transaction has been completed or until the date of expiry of the search has been reached, whichever is earlier.

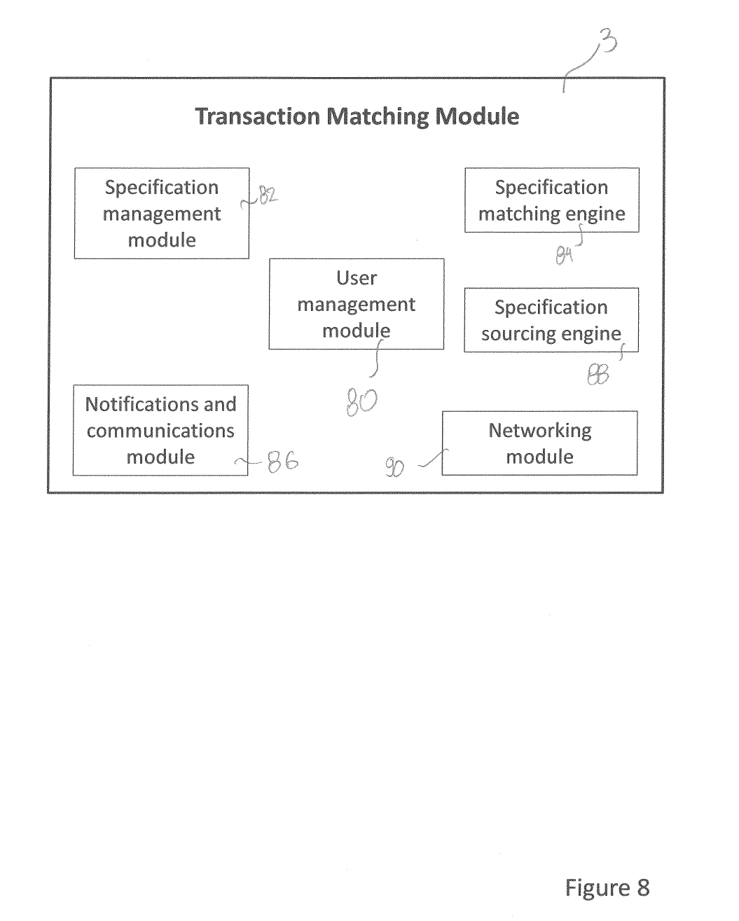

Referring now to FIG. 8, the transaction matching module 3 of FIG. 1 is shown in greater detail. The transaction matching module 3 may be logically divided in a user management module 80, a specification management module 82, a specification matching engine 84, a notification module 86, a specification sourcing engine 88 (sourcing engine) and a networking module 90.

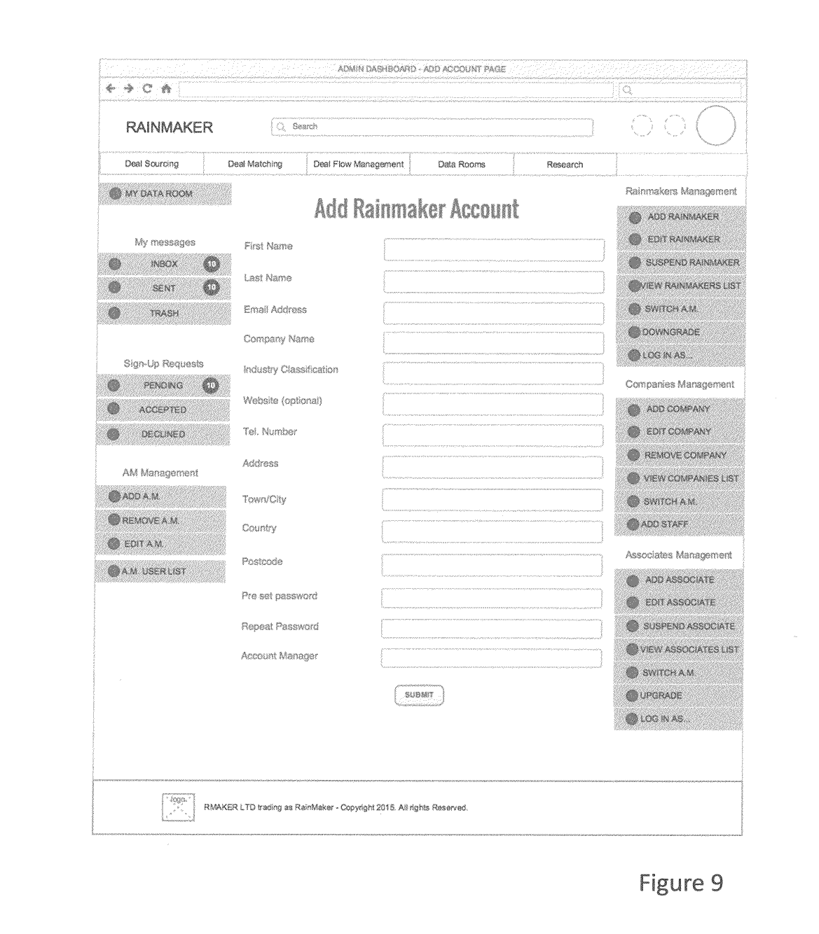

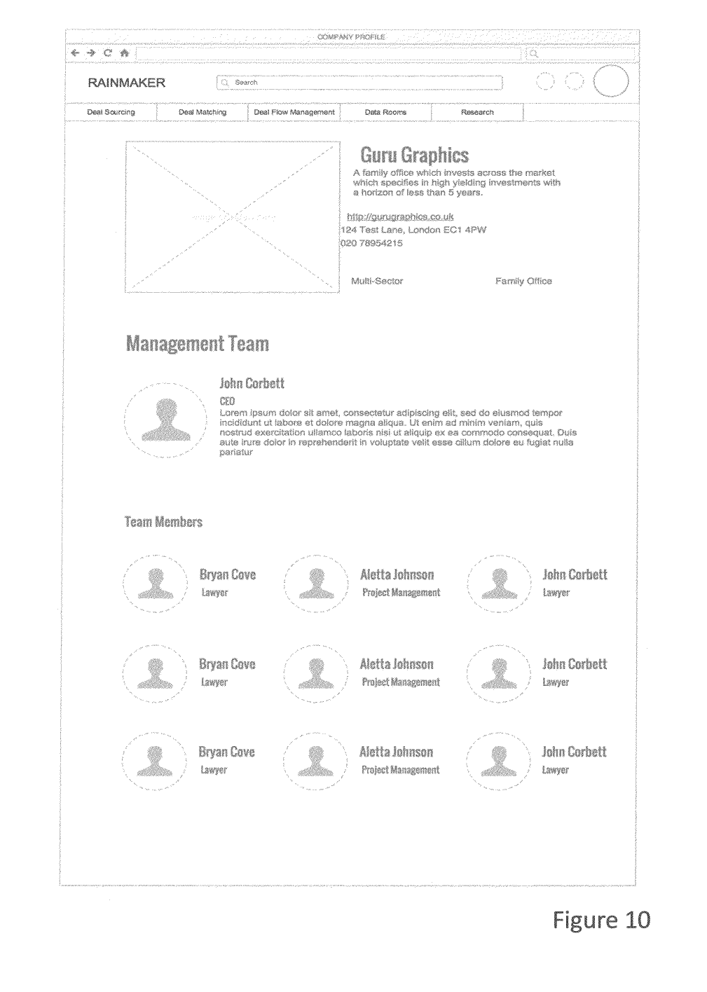

The user management module 80 provides an interface for a main user (buyer or seller) to set up and update an organization profile and their personal user profile. In addition to this, the user management module allows the main user (buyer or seller) to ‘add’ staff users and associate users who can have access to different subsets of data. A graphical user interface in accordance with an embodiment of the present invention illustrating a user profile of a main user can be seen in FIG. 9. A graphical user interface illustrating an organization account being set up can be seen in FIG. 10. Different types of users have access to different subsets of the organization's files and different capabilities of the system. The user management module 80 also allows a user to remove staff or associate users.

The networking module 90 is also referred to as an unlocking allows a buyer to send and a seller to refuse, accept or ignore an unlock request. The networking module 90 also allows a user to form a temporary connection with another user. A temporary connection is a connection that gives users mutual access to each other's locked specification and the capability to communicate with each other via instant messaging. A temporary connection between a buyer and a seller is formed when the seller accepts the buyer's unlock request and lasts until the two users either move the transaction to the transaction flow management stage or decide that they do not wish to proceed with the transaction. Furthermore, the networking module 90 allows a user to use instant messaging with any of the users there are connected to (‘contacts’), as well as to view and edit their contact list.

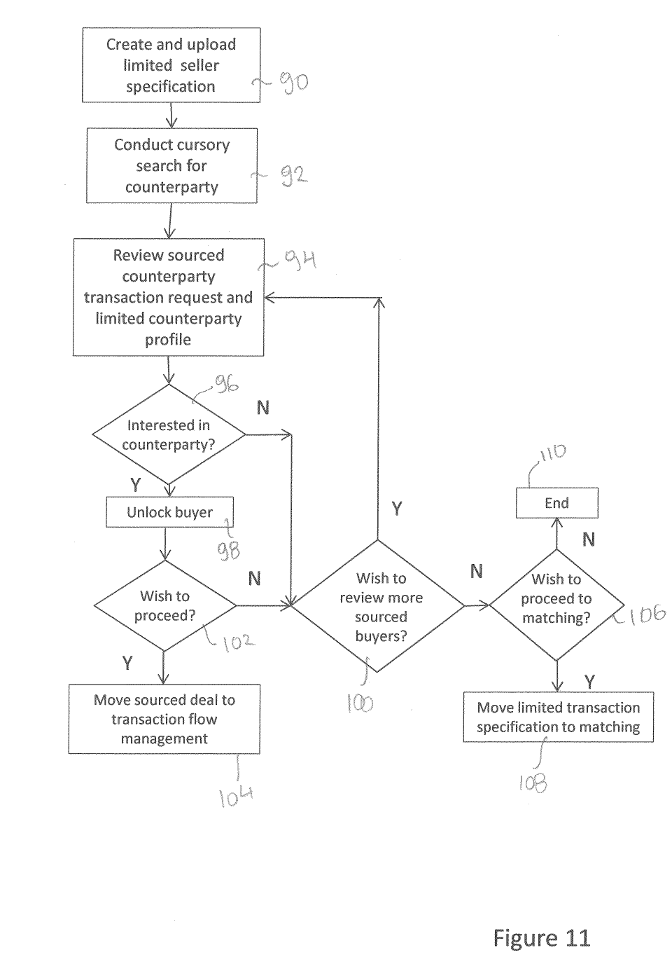

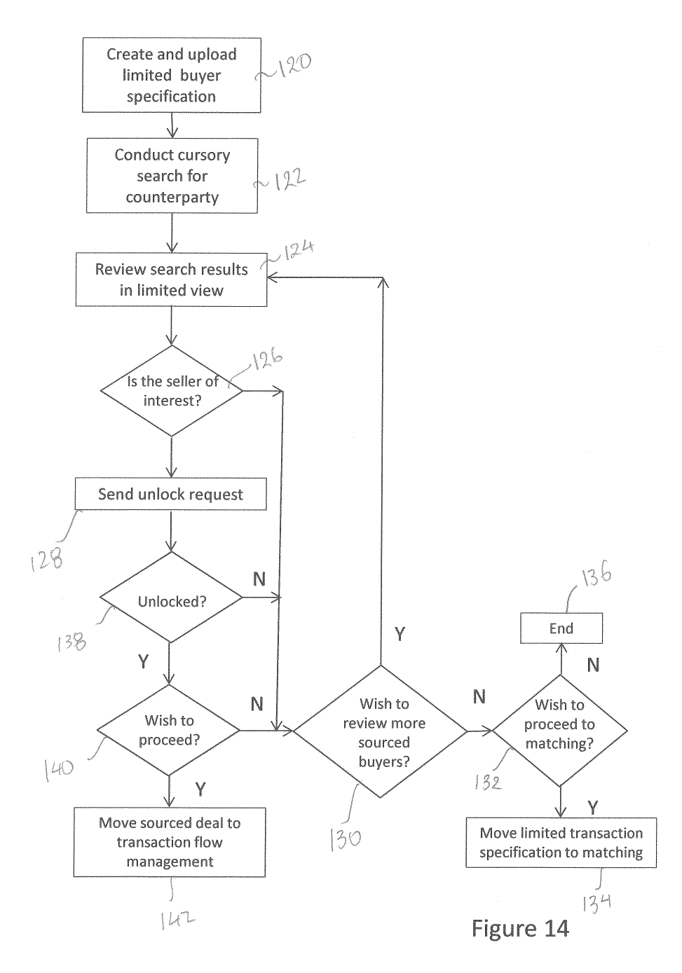

The specification management module 82 provides an interface for the user to upload and save a transaction (seller) specification. The specification management module 82 also ensures that the seller specification 20 is divided into the search specification (non-locked portion) 20b, accessible to the matching engine and all matched users, and the locked specification (locked portion) 20a, accessible by the deal flow management module 5 and the non-locked users. In addition to this, the specification management module 82 also allows a user to view their saved transaction specifications and edit or delete them. The specification management module 84 further provides an interface for a user to upload a limited search specification (limited buyer search specification or limited seller search specification). The use of this type of limited specification will be described in more detail with reference to FIGS. 11 and 14.

The matching engine 84 performs searches to match active seller specifications 20 with active buyer specifications 22. For each active seller specification 20, the matching engine 84 identifies all the buyer specifications 22 that fulfill the parameters set out in the seller search specification 22b. Similarly, for each active buyer specification 22, the matching engine identifies all the seller specifications 20 that fulfill the parameters set out in the buyer search specification.

The sourcing engine 88 performs searches to match active limited seller search specifications with active buyer specifications 22. For each active limited seller search specification, the sourcing engine 88 identifies all the buyer specifications that fulfill the parameters set out in the limited seller search specification. Similarly, for each active limited buyer search specification, the sourcing engine identifies all the seller specifications 20b that fulfill the parameters set out in the limited buyer search specification.

The notifications and communications module 86 transmits notifications to the user every time the specification matching engine identifies a new specification that matches the user's specification. The notifications and communications module 86 also transmits notifications to the user every time the specification sourcing engine 88 identifies a new specification that matches the user's limited specification. The notifications can be made in a variety of ways such as email, text message etc. However, in some embodiments the messaging is made within the GUI which enables the notification to be categorized with respect to its content, namely if the message relates to a specific Deal, and the message can be attached to the portion of the GUI showing the details for that deal. Furthermore the notifications and communications module 86 transmits notifications to the user every time a new request for unlock is received at the networking module.

The specification management module in combination with the sourcing engine further provide a functionality for an interested registered party to perform a cursory review (‘specification sourcing’) of potential counterparties without going through the entire process of transaction matching.

A functional overview of the sourcing functionality as seen from a seller's and a buyer's point respectively is now described with reference to FIGS. 11 and 14.

Turning to FIG. 11, a registered party interested in selling an asset (‘seller’) initially creates and uploads, at Step 90, a limited seller search specification. To set up the limited seller specification, the seller inputs various parameters relating to the transaction they wish to carry out and the desired buyer they wish to work with. This limited seller specification contains much fewer parameters than a seller specification and is a subset of the seller specification.

Typically, the parameters of a limited seller search specification would be limited to:
One Liner (brief summary of the type of transaction the seller is interested in)
Expiry (Expiry date of the transaction)
Geographical Region (the geographical region the seller is interested in)
Deal Size (size of the target buyer party)
Industry classification (the industry classification of the desired buyer)
Current Revenue (current revenue to buyer is after)

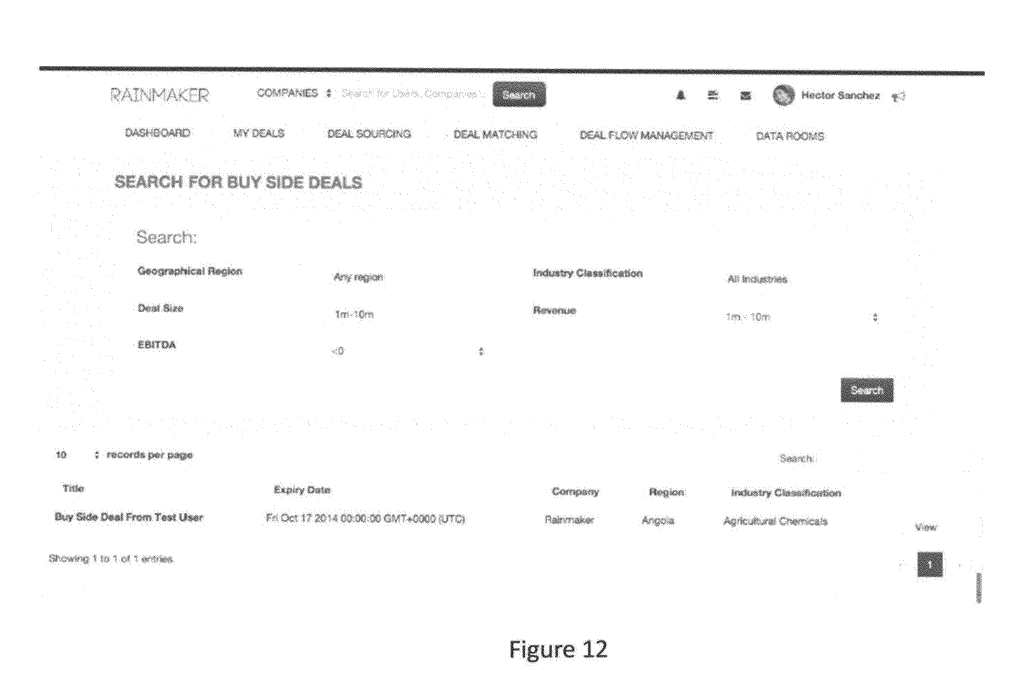

An example of a limited seller search specification form can be seen in FIG. 12.

Subsequently, a cursory review of all active buyer specifications is conducted by the sourcing engine at Step 92.

The seller then receives, at Step 94, a list of limited buyer specifications (limited results′) from the transaction sourcing engine 88 conducting a search of the buyer specifications 22 stored in the data store that match the requirements set out on the limited seller specification. The search is conducted by the sourcing engine.

For each buyer on the limited results list, the seller is able to view a subset of the parameters included in the buyer search specification (limited buyer specification′). The parameters visible at this stage typically include:
Deal title
Limited buyer profile
Expiry date
Company
Geographical region
Industry classification

Reviewing, at Step 94, each sourced limited buyer specification on the results set individually, the seller can then choose, at Step 96, whether they are interested in the buyer.

This step 96 is effectively a preliminary filter. The seller can see some basic information about each buyer that matches the requirements of their limited seller search specification and, based on that information, the seller can determine whether choosing them as a counterparty for the transaction is of interest.

If the seller determines that the buyer is a counterparty of interest, then the seller unlocks the buyer at Step 98.

If it is determined, at Step 96, that the buyer is not a counterparty of interest, the prospective buyer is removed from the limited results set and it is examined, at Step 100 whether the seller wishes to review more buyers from the remainder of the limited results set.

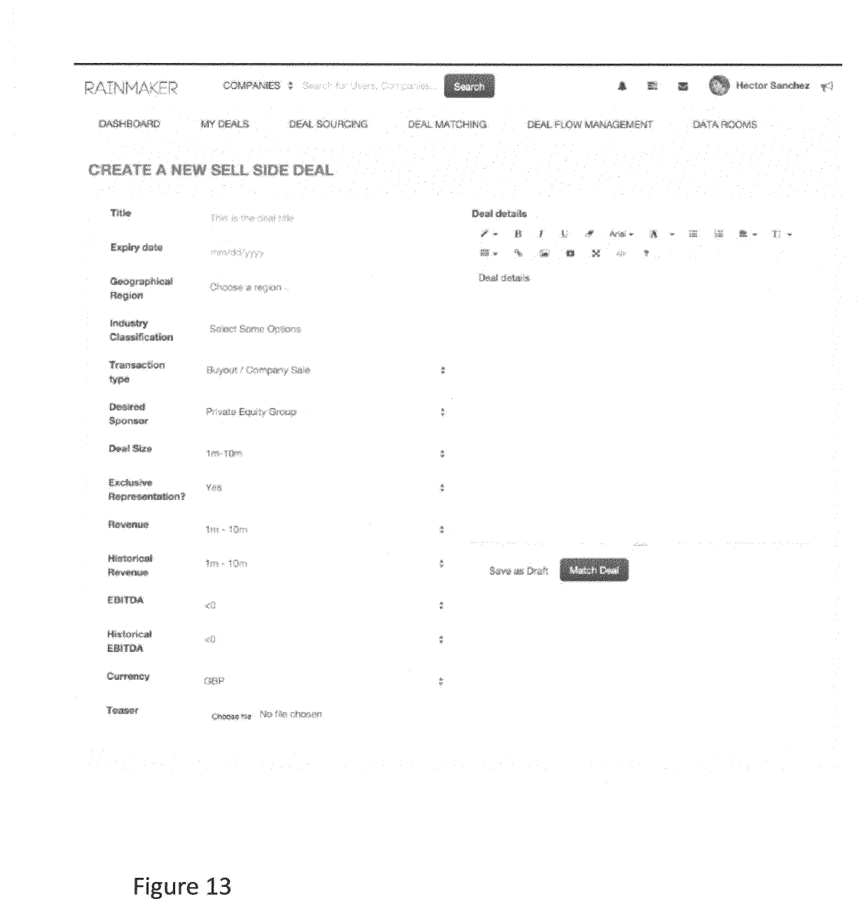

It should be noted that upon unlocking a buyer, at Step 98, the seller optionally provides more parameters regarding their information. An exemplary view of those parameters can be seen in FIG. 13.

It is then examined at Step 102, whether both parties wish to proceed with the transaction.

Unless one of the parties then indicates that they do not wish to proceed with the transaction, the transaction is subsequently moved, at Step 104, to transaction flow management (‘deal flow management’).

If however it is determined, at Step 102, that one of the parties does not wish to proceed with the transaction, the prospective buyer is removed from the limited results set and it is examined, at step 100, whether the seller wishes to review more buyers from the remainder of the limited results set.

If it is determined that the seller wishes to continue reviewing sourced buyers, then the seller continues reviewing, at Step 94, each matched limited buyer specification on the results set individually.

If it is determined, at Step 100, that the seller does not wish to continue reviewing sourced buyers, it is subsequently examined, at Step 106, whether the seller would like to proceed to full transaction specification matching. If so, the already input parameters of the limited seller specification are migrated to a full seller search specification and the seller proceeds with transaction matching at Step 108. If not, then the seller may end the process, at Step 110.

The same transaction sourcing process is now functionally described from the point of view of a party that wishes to purchase an asset (buyer), with reference to the flow diagram of FIG. 14.

Turning to FIG. 14, the registered party initially creates and uploads, at step 120 a limited buyer search specification. This limited buyer specification contains much fewer parameters than a buyer search specification.

Typically, the parameters of a limited buyer search specification are limited to:
One Liner (brief summary of the type of transaction the seller is interested in)
Expiry (Expiry date of the transaction)
Geographical Region (the geographical region the seller is interested in)
Deal Size (size of the target buyer party)
Industry classification (the industry classification of the desired buyer)
Transaction Type
Desired sponsor
Exclusive representation

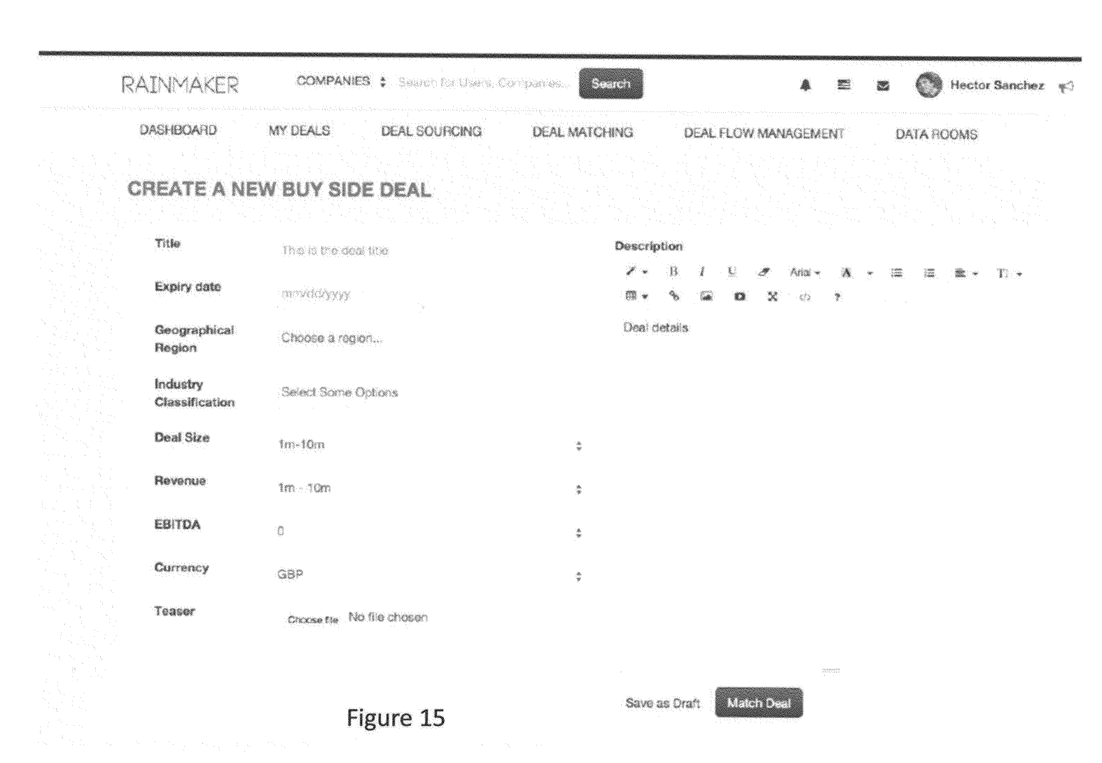

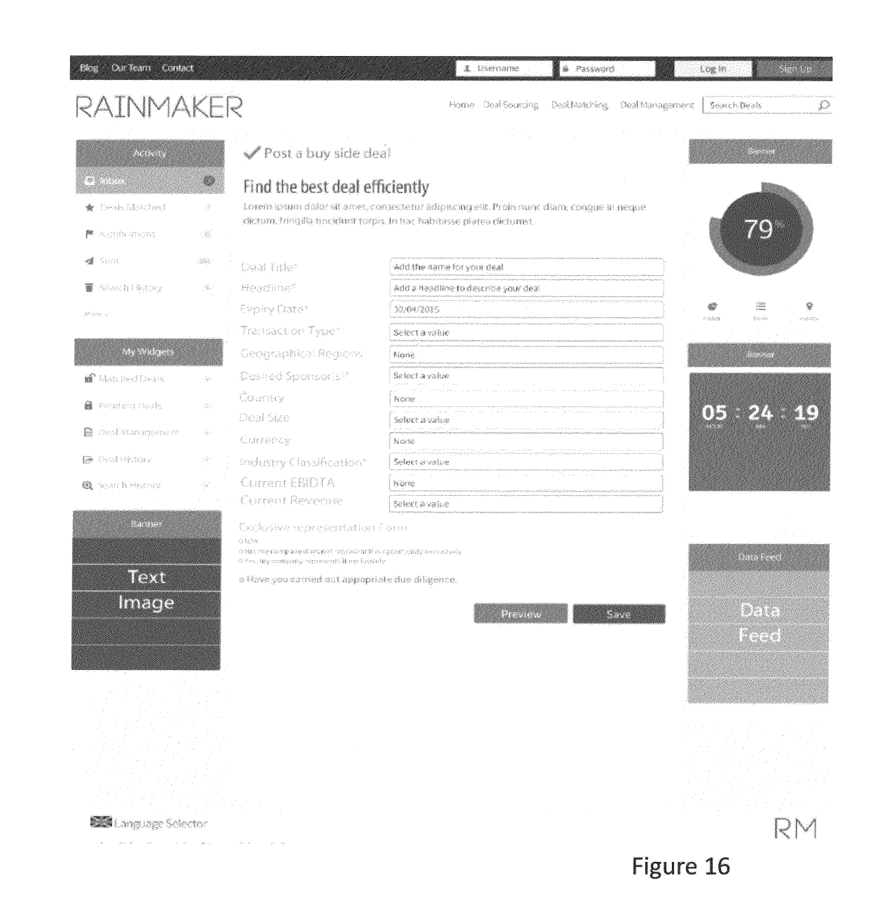

An example of a limited buyer search specification form can be seen in FIG. 15.

The buyer then receives, at Step 124, a list of limited seller specifications (limited results′) from the transaction matching module 3 conducting a search at Step 122 of the buyer specifications 22 stored in the data store 9) that match the requirements set out on the seller's limited search specification.

For each seller on the limited results list, the buyer is able to view a subset of the parameters included in the seller search specification. The parameters visible at this stage typically include:
One liner
Expiry Date
Transaction Type
Geographical region
Deal Size
Exclusive representation

The buyer then reviews, at Step 124, each matched limited seller specification on the results set individually. The buyer can then choose, at Step 126, whether they are interested in the seller.

This step 126 is effectively a preliminary filter. The buyer can see some basic information about each seller that matches the requirements of their limited buyer search specification and, based on that information, the buyer can determine whether choosing them as a counterparty for the transaction is of interest.

If the buyer determines at Step 126 that the seller is a counterparty of interest, then the buyer sends the seller a request to unlock at Step 128.

If it is determined, at Step 126, that the seller is not a counterparty of interest, the prospective seller is removed from the limited results set and it is examined, at Step 130, whether the buyer wishes to review more sellers from the remainder of the limited results set.

If it is determined, at Step 130, that the buyer does not wish to continue reviewing sourced sellers, it is subsequently examined, at Step 132, whether the buyer would like to proceed to full transaction specification matching. If so, the already input parameters of the limited buyer specification are migrated to a full buyer search specification and the buyer proceeds with transaction matching at Step 134. If not, then the buyer may end the process, at Step 136.

It is then examined, at Step 138, whether the buyer has been unlocked.

If it is determined, at Step 138, that the buyer has not been unlocked, the prospective seller is removed from the limited results set and it is examined, at step 130, whether the buyer wishes to review more sellers from the remainder of the limited results set.

If it is determined that the buyer wishes to continue reviewing sourced sellers, then the buyer continues reviewing, at Step 124, each matched limited seller specification on the results set individually.

If it is determined, at Step 130, that the buyer does not wish to continue reviewing sourced sellers, it is subsequently examined, at Step 132, whether the buyer would like to proceed to full transaction specification matching. If so, the already input parameters of the limited buyer specification are migrated to a full buyer search specification and the buyer proceeds with transaction matching at Step 134. If not, then the buyer may end the process, at Step 136.

If it is determined, at Step 138 that the buyer has been unlocked, then it is examined, at Step 140, whether both parties wish to proceed with the transaction.

Unless one of the parties then indicates, at Step 140 that they do not wish to proceed with the transaction, the transaction is subsequently moved, at Step 142, to transaction flow management (‘deal flow management’).

If however it is determined, at Step 140, that one of the parties does not wish to proceed with the transaction, the prospective seller is removed from the limited results set and it is examined, at step 130, whether the buyer wishes to review more buyers from the remainder of the limited results set.

If it is determined that the buyer wishes to continue reviewing sourced sellers, then the buyer continues reviewing, at Step 124, each matched limited seller specification on the results set individually.

If it is determined, at Step 130, that the buyer does not wish to continue reviewing sourced sellers, it is subsequently examined, at Step 132, whether the buyer would like to proceed to full transaction specification matching. If so, the already input parameters of the limited buyer specification are migrated to a full buyer search specification and the buyer proceeds with transaction matching at Step 134. If not, then the buyer may end the process, at Step 136.

To complement this, the system also provides a transaction management module (‘deal flow management module 5’), which allows members to maintain and track the progression of their deals at one source. The primary aim of the deal flow management module 5 is to centralize all the information needed by all users to drive deals forward quickly. The deal flow management module 5 provides an extensive list of features created to help M&A professionals to manage deals effectively and to complete deals in a timely manner in any location.

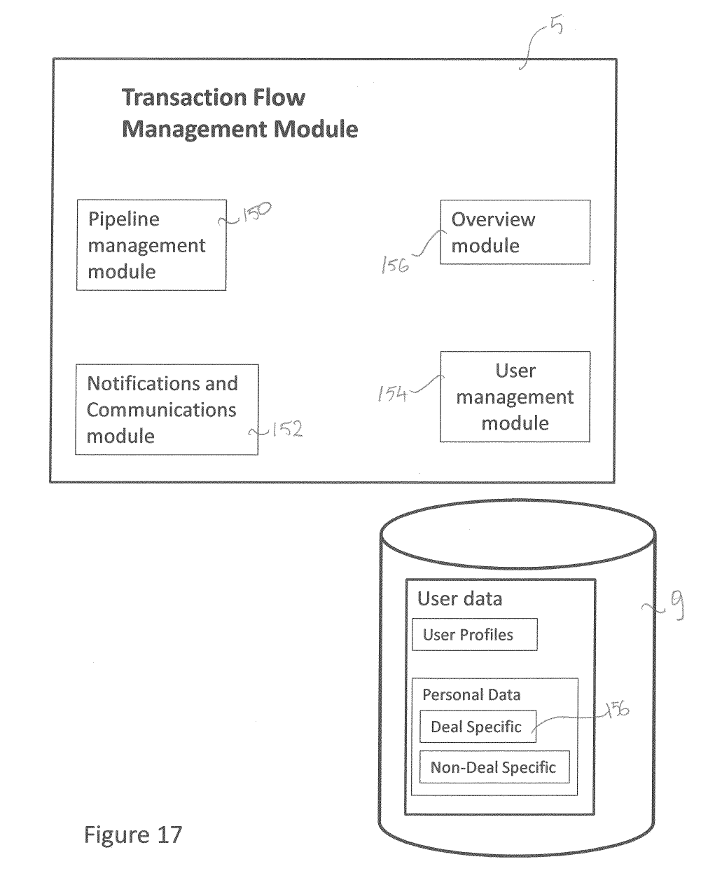

The overall architecture of the transaction flow management module 5 embodying the present invention is now described referring to FIG. 17. The transaction flow management module 5 comprises a pipeline management module 150, a notifications and communications module 152, a user management module 154 and an overview module 156.

The user management module 154 provides an interface to allow a user to set up an organization profile and designate the staff users that will be involved in the transaction. The user management module 154 further allows the main user of the party to add or remove the designated staff. In addition to this, the user management module communicates with the datastore 9 of the system shown in FIG. 1 and enables the creation of a private transaction-specific datastore 9 for each counterparty, the creation of a shared transaction-specific subset of the private, transaction-specific datastore 156 of each counterparty, and the assignment of staff users by each counterparty.

The private, transaction-specific datastore 156 of each counterparty is where a buyer or a seller can upload and store files relevant to the transaction. Each counterparty designates a subset of their private transaction-specific datastore 156 to which the other counterparty will have access. Upon designating the staff users, the counterparty also assigns them different tasks and permissions. This is done in order to increase the efficiency and speed of the transaction flow, as file sharing becomes faster and easier.

The pipeline management module 150 provides an interface to allow a party to customize their transaction flow management pipeline by adding the tasks they wish at each stage.

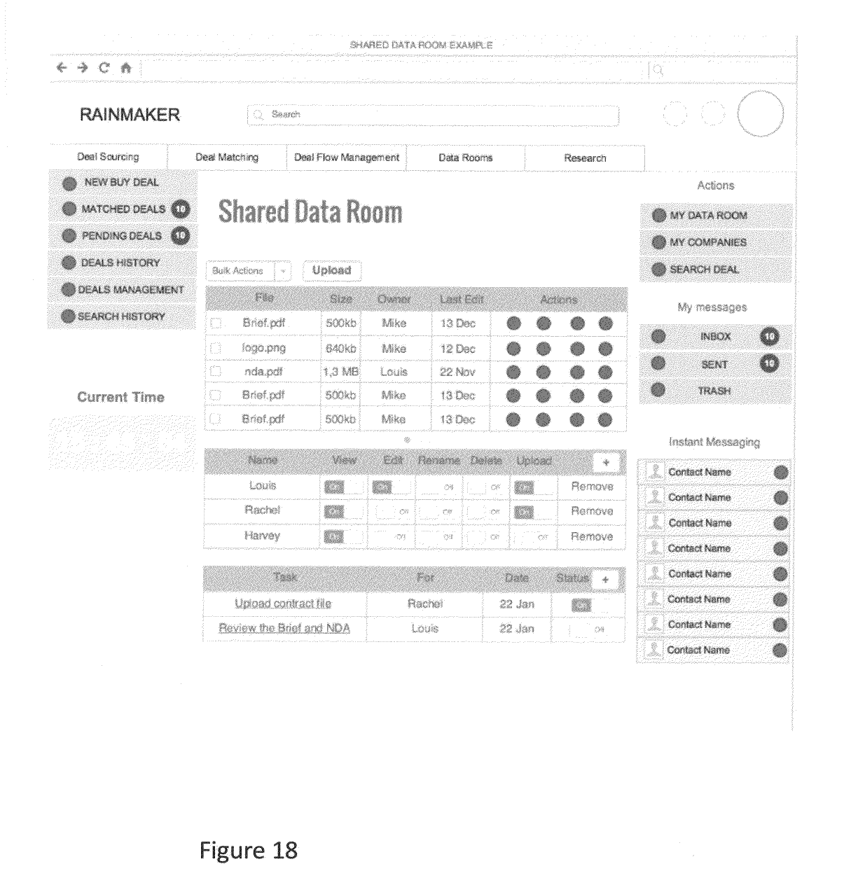

Setting up a flow management pipeline involves each party outlining what tasks they wish to complete on every stage of the transaction flow management process in order to complete the transaction. Traditionally, in the field of mergers and acquisitions, a transaction must pass through the stages of initial analysis, evaluation, negotiation and closing in order to be completed. Upon setting up their individual transaction management pipeline, each party outlines what tasks they wish to carry out in every one of those stages. A task may be individual or collaborative. An individual task is a task that can be completed by members of one of the two counterparties alone (such as drawing up a legal document). A collaborative task is a task that needs the collaboration of the both counterparties to be completed (such as facilitation of site visits). An example of an interface illustrating the different tasks assigned to different staff users and files accessible by different staff users can be seen in FIG. 18. Upon setting up the tasks of the stages of the transaction flow management, the pipeline management module 150 also enables a counterparty also assigns those tasks to specific staff users and, where appropriate, to their counterparty.

To elucidate the significance of this tailored approach to the design of the transaction flow management pipeline, a short description of its capabilities is given below.

As each counterparty has set up their own transaction management pipeline, the two counterparties will likely have different tasks to complete.

Once a counterparty completes all the tasks set for that stage, it may move on to the next stage.

Usually, a counterparty will first pursue to complete the individual tasks set in the current stage. Once these are complete, it can move on to the collaborative tasks of that stage. If the stage contains no collaborative tasks, then the counterparty may move on to the next stage, regardless of whether the other counterparty has completed the corresponding stage.

If however the stage does contain collaborative tasks, then the counterparty cannot move on to the next stage, in this case, the evaluation stage, until the collaborative tasks have been completed too.

It should be noted that a party may decide to abandon the process and return to transaction matching at any point. There are various reasons why a party may choose to do that: they may be unhappy with the speed of processing of their counterparty, they may decide that their counterparty is unsuitable, they might get a notification from the matching system that a more suitable counterparty has been found (as the transaction matching process does not stop until the transaction has been completed) or they might successfully complete a transaction with another counterparty (as it is possible to be in the transaction flow management process for the same transaction with more than one counterparties). Returning to the description of the architecture of the transaction flow management system of FIG. 17, the notifications and communications module 152 provides an interface for notifications to be transmitted to the user every time the specification matching engine 84 identifies a new specification that matches the user's specification. The notifications and communications module 152 also transmits notifications to the user when a task of a stage has been completed. In addition to this, a connection is formed between two counterparties working on the same transaction, and the communications and notifications module allows them to communicate by means of messaging and instant messaging. It should be noted that this connection extends to the staff users designated by each counterparty. The notifications can be made in a variety of ways such as email, text message etc. However, in some embodiments the messaging is made within the GUI which enables the notification to be categorized with respect to its content, namely if the message relates to a specific Deal, and the message can be attached to the portion of the GUI showing the details for that deal. Furthermore the notifications and communications module 152 transmits notifications to the user every time a new request for unlock is received at the networking module.

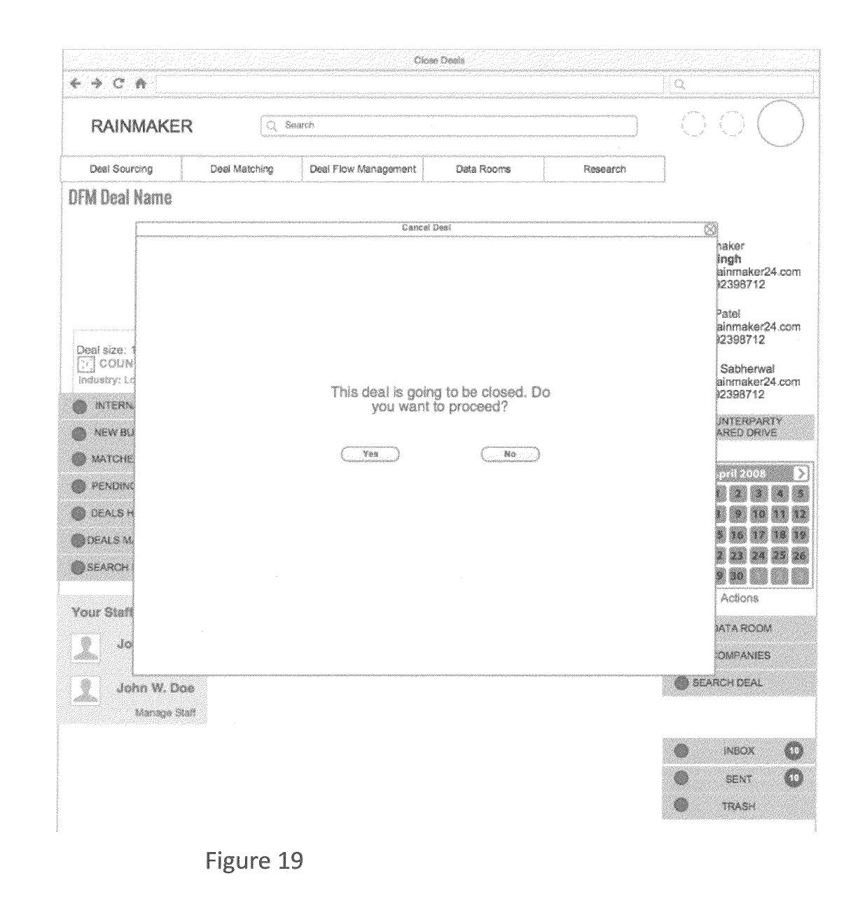

An example of a notification received by a user once a transaction has been cancelled can be seen in FIG. 19.

The overview module 156 provides an interface to allow a user to review all the transactions they are working on at any point in time. Some of the features of the overview module may include but are not limited to, a dashboard showing the matched, pending and searched transactions of the user, a ‘smart’ event calendar illustrating outstanding invoices, transactions and tasks and a form of graphical representation such as a pie chart, indicating the level of completion of each managed transaction.

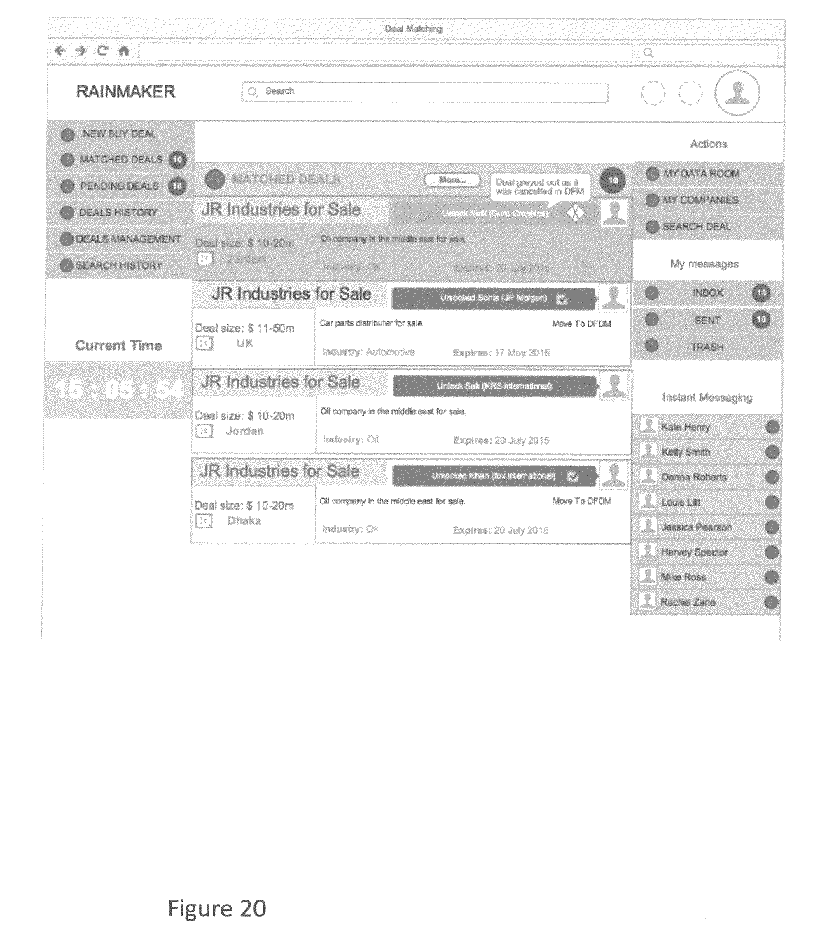

An example of a cancelled transaction as part of the transaction portfolio as may be seen by a user via the overview module 156 can be seen in FIG. 20.

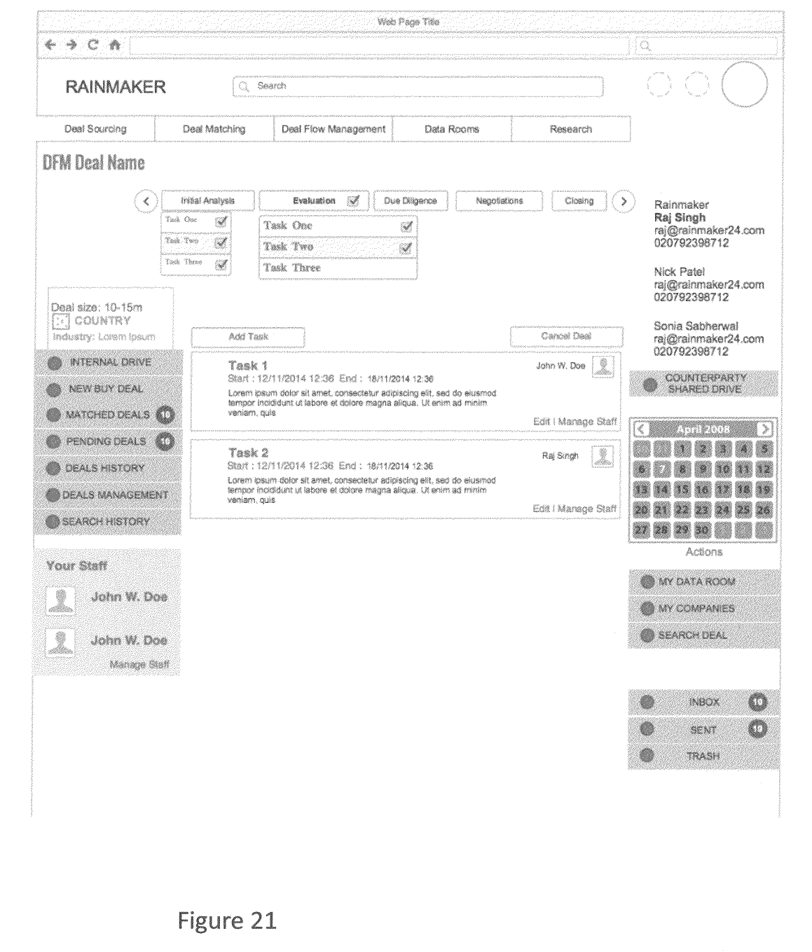

An example of an interface illustrating the level of completion of a transaction can be seen in FIG. 21.

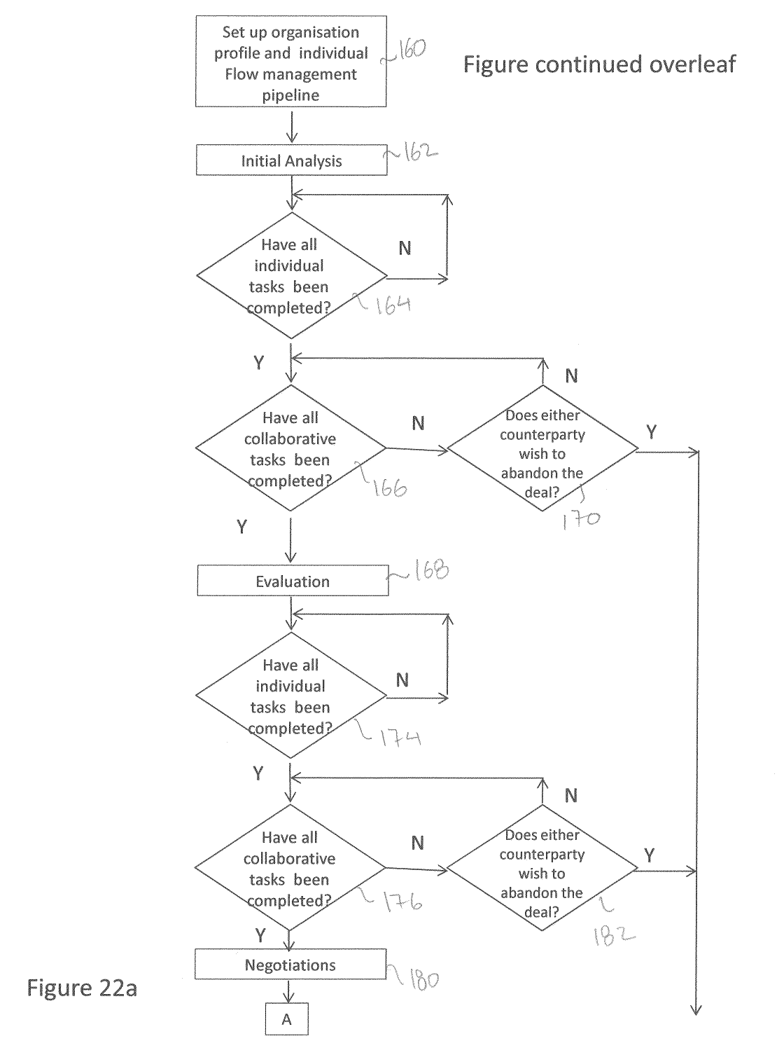

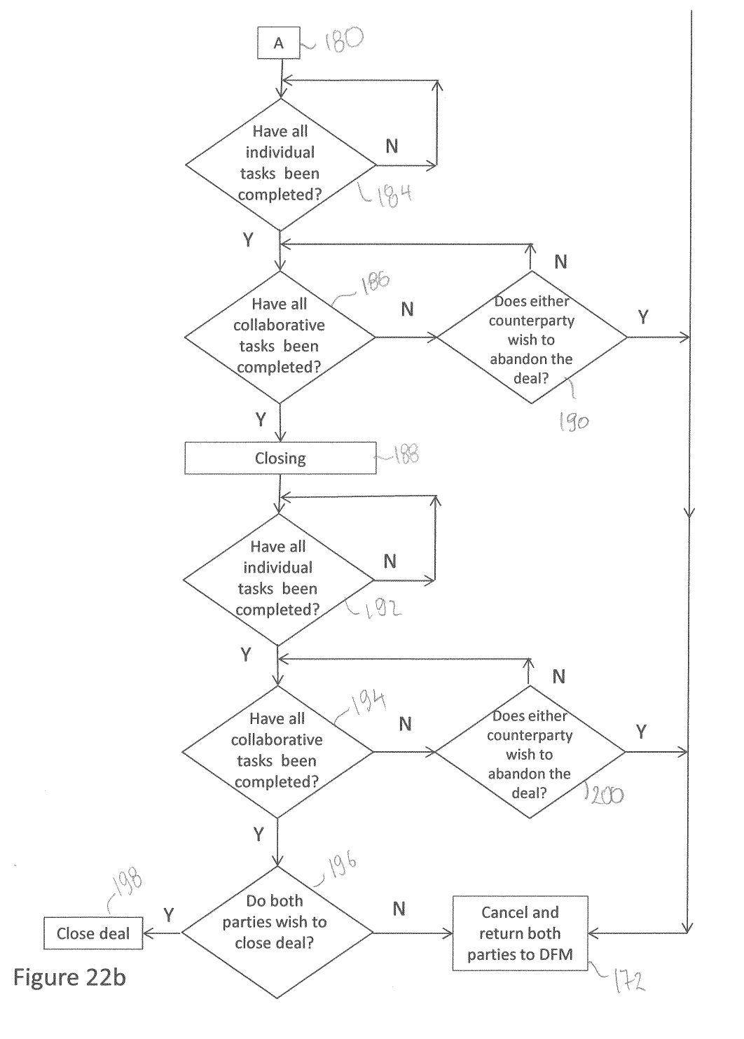

An overview of the transaction management process will now be described with reference to FIGS. 22a and 22b.

Upon entry into the transaction flow management process, each counterparty sets up, at Step 160, their organization profile, they outline their individual flow management pipeline and a connection is established between them and counterparty.

Once the two counterparties have been set up as described above, the initial analysis stage begins, at Step 162.

The initial analysis stage may include tasks such as, but not limited to, preparing of confidentiality agreements, selecting a buyer universe, preparing marketing materials, performing preliminary valuation analysis, identifying seller objectives and determining an appropriate sale process.

The party first completes all individual tasks in the initial analysis stage. Once these have been completed, it is examined whether the collaborative tasks have been completed by their counterparty.

If it is determined at Step 166 that the collaborative tasks have been completed too, or that there are no collaborative tasks, the party moves, at Step 168 on to the evaluation stage.

If it is determined, at Step 166, that the collaborative tasks have not been completed (or have been only partially completed), it is examined, at Step 170 whether either of the parties wishes to abandon the transaction.

If it is determined that neither party wishes to abandon the transaction then the party goes back to the examining step 166, and the process is repeated until the party can move on to the evaluation stage.

If it is determined that either party wishes to abandon the transaction, then the transaction is cancelled at Ste 172. Both parties receive a notification of the deal cancellation, the connection between the counterparties is discontinued and the transactions exit the transaction flow management process.

The evaluation stage may include tasks such as, but not limited to, contacting prospective buyers, negotiating and executing confidentiality agreements, distributing bid procedures' letters, preparing management presentations, facilitating site visits and receiving final bids.

The party first completes all individual tasks in the evaluation stage. Once these have been completed, it is examined at Step 176, whether the collaborative tasks have been completed by their counterparty.

If it is determined, at Step 176, that the collaborative tasks have been completed too, or that there are no collaborative tasks, the party moves on to the negotiations stage at Step 180.

If it is determined that the collaborative tasks have not been completed (or have been only partially completed), it is examined, at Step 182, whether either of the parties wishes to abandon the transaction.

If it is determined at Step 182 that neither party wishes to abandon the transaction then the party goes back to the examining step 176, and the process is repeated until the party can move on to the negotiations stage.

If it is determined at Step 182, that either party wishes to abandon the transaction, then the transaction is cancelled at Step 172. Both parties receive a notification of the deal cancellation, the connection between the counterparties is discontinued and the transactions exit the transaction flow management process.

The negotiations stage may include tasks such as, but not limited to, evaluating final bids, negotiating with a buyer, rendering a fairness opinion, receiving board approval and executing a definitive agreement.

The party first completes all individual tasks in negotiations stage. Once these have been completed, it is examined at Step 190 whether the collaborative tasks have been completed by their counterparty.

If it is determined at Step 186 that the collaborative tasks have been completed too, or that there are no collaborative tasks, the party moves on to the closing stage 188.

If it is determined that the collaborative tasks have not been completed (or have been only partially completed), it is examined at Step 190 whether either of the parties wishes to abandon the transaction.

If it is determined at Step 190 that neither party wishes to abandon the transaction then the party goes back to the examining step 186, and the process is repeated until the party can move on to the closing stage.

If it is determined at Step 190 that either party wishes to abandon the transaction, then the transaction is cancelled at Step 172. Both parties receive a notification of the deal cancellation, the connection between the counterparties is discontinued and the transactions exit the transaction flow management process.

The final closing stage 188 may include tasks such as, but not limited to, obtaining necessary approvals, financing and closing of the transaction.

The party first completes all individual tasks in the initial closing stage. Once these have been completed, it is examined at Step 194, whether the collaborative tasks have been completed by their counterparty.

If it is determined at Step 194 that the collaborative tasks have not been completed (or have been only partially completed), it is examined at Step 200 whether either of the parties wishes to abandon the transaction.

If it is determined at Step 200 that neither party wishes to abandon the transaction then the party goes back to the examining step 194, and the process is repeated until the parties have completed all the closing stage tasks.

If both parties agree to close the transaction at Step 196, the transaction is completed at Step 198. Each user receives a notification and the matching searches that are being carried out with respect to their respective buyer and seller transaction specifications are discontinued.

If it is determined at Step 196, that either party wishes to abandon the transaction, then the transaction is cancelled at Step 172. Both parties receive a notification of the deal cancellation, the connection between the counterparties is discontinued and the transactions exit the transaction flow management process.

It should be noted that a designed pipeline is not static but dynamic. While still in the flow management process, a party may go back a few stages and request that an additional task be completed.

An additional feature of the system is that it allows members to manage deals online using the system's tools even if those deals were originally sourced and matched offline without using the system.

For a registered party to manage a transaction using the transaction flow management according to an embodiment of the present invention, it is not imperative for that transaction to have been matched using the transaction matching process according to the previously described embodiment of the present invention.

In fact, it is frequently the case that a party has found an interested counterparty without using the previously described process. The non-matched counterparty may be a registered user of the system of the embodiment described herein or not. The process required to enter the transaction flow management process with a non-matched member may be referred to as offline matching.

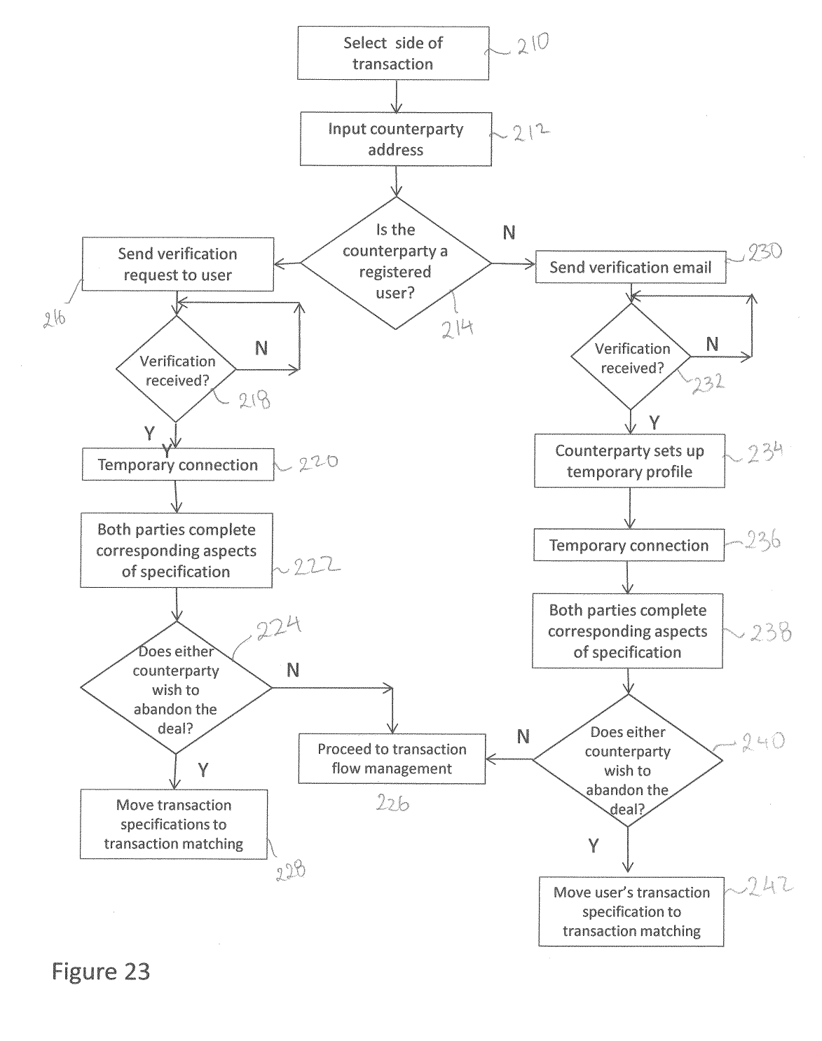

The offline matching process according to an embodiment of the present invention will be described below with reference to FIG. 23.

Initially, the registered party selects at Step 210 whether they are on the buying or selling side of the transaction.

Subsequently, the registered party may input at Step 212 the email address or other form of contact details of the counterparty of interest.

It is then examined at Step 214 whether the email address of the inputting step corresponds to another registered user.

If it is determined that the email address corresponds to another registered user, then a verification request is sent, at Step 216 to that user via the communications module 7 illustrated in FIG. 1.

It is then examined at Step 218 whether a verification is received.

If it is determined that a verification has been received, then a temporary connection between the counterparties is set up at Step 220.

Subsequently, each party completes a transaction specification and reviews their counterparty's transaction specification at Step 222.

Once each party has reviewed the counterparty's transaction specification, it is examined at Step 224 whether either of the counterparties wishes to abandon the transaction.

If it is determined at Step 222 that both parties wish to follow through with the transaction, then the transaction proceeds at Step 226 to the flow management process described with reference to FIGS. 22a and 22b.

If it is determined that either party wishes to abandon the transaction, then each party's transaction proceeds at step 228 to the transaction matching process described with reference to Figures and 6.

Going back to the determining step 214, if it is determined that the email address does not correspond to another registered user, then a verification email is sent at Step 232 to that email address via the communications module 7 illustrated in FIG. 1.

It is then examined at Step 234 whether a verification is received.

If it is determined at Step 232 that a verification has been received, then the counterparty sets up a temporary profile at Step 234.

Subsequently, a temporary connection between the counterparties is set up at Step 236.

Subsequently, each party completes a transaction specification and reviews their counterparty's transaction specification at Step 238.

Once each party has reviewed the counterparty's transaction specification, it is examined at Step 240 whether either of the counterparties wishes to abandon the transaction.

If it is determined that both parties wish to follow through with the transaction, then the transaction proceeds at Step 226 to the flow management process described with reference to FIGS. 22a and 22b.

If it is determined that either party wishes to abandon the transaction, then the registered party's transaction proceeds to the transaction matching process described with reference to FIGS. 3 and 6. The non-registered counterparty is presented with the choice to register as a user and have their transaction specification moved to the transaction matching process. If they do not wish to proceed with registering, the non-registered user's temporary user profile is removed and their temporary connection to the registered user is discontinued.

What is claimed is:

1. A deal management system, the system comprising:
a database storing a plurality of sell specifications from a set of first users and a plurality of buy specifications from a plurality of second users, each of the sell specifications comprising a locked portion of data and a non-locked portion of data;
a matching module for matching a search specification with one or more of the sell specifications, the matching module comprising:
a search engine for searching the non-locked portions of the plurality of sell specifications, and
a networking module for sending an unlock request to a first user associated with a sell specification matched to the search specification and providing the locked portion of information of a matched sell specification to a second user associated with the matched searching specification in response to receiving an unlock permission from the first user; and
a flow management module for managing a plurality of tasks associated with a specification acceptance process, the flow management module being responsive to a positive selection of a matched specification by a first user and a second user and to provide a graphical user interface (GUI) for managing the plurality of tasks until such time as the first and second users have accepted each other's buy and sell specifications and a deal regarding those specifications has been completed.

2. A deal management system of claim 1, wherein the unlocked portion of the sell specifications does not reveal the identity of the first user to whom the sell specification relates.

3. A deal management system of claim 1, wherein the database comprises at least one data room providing a repository for documents and information relating to a matched buy and sell specification, the at least one data room having a set of access permissions associated therewith to determine which specific users can read data provided in or write data to the at least one data room.

4. A deal management system of claim 1, wherein the database comprises a plurality of user profiles for the first and second users, each user profiles specifies a plurality of personnel associated with the user and each of the personnel's associated access rights to stored data relating to the user.

5. A deal management system of claim 1, wherein the database comprises personal user data comprising deal-specific personal data and non-deal specific personal data.

6. A deal management system of claim 1, wherein the search engine of the matching module is arranged to search the plurality of buy specifications and the networking module is further arranged to send a connect request to a second user associated with a buy specification matched to the sell specification, the connect request providing access to the locked portion of information of a matched sell specification to the second user associated with the buy specification.

7. A deal management system of claim 1, wherein the networking module is arranged to establish a temporary communications channel between a first user and a second user once both the first and second users of matched buy and sell specifications have access to each other's buy and sell specifications.

8. A deal management system of claim 1, wherein the temporary communications channel comprises an instant messaging communications channel.

9. A deal management system of claim 1, wherein the matching module comprises a user management module which is arranged to enable a user to set up an organization user profile and to configure access rights to data for different personnel associated with the organization.

10. A deal management system of claim 1, wherein the matching module comprises a specification management module which is arranged to provide a user interface for the plurality of first or second users to enable a user to upload, edit and save a buy or sell specification and to specify which portion of the sell specification is to be the locked portion.

11. A deal management system of claim 1, wherein the specification management module is arranged to enable a user to upload a limited search specification for a buy specification or a sell specification and to store the same in the database; wherein each limited search specification comprises a subset of the data of a corresponding buy specification or sell specification.

12. A deal management system of claim 1, wherein the matching module further comprises a sourcing engine arranged to conduct user specified searches on the limited search specifications stored in the database.

13. A deal management system of claim 1, wherein sourcing engine enables a remotely located user to search the non-locked portions of the plurality of sell specifications without revealing the identity of the remotely located user; and a networking module for generating a request for unlocking the locked portion of any matched sell specifications, the request including further detailed information about the remote user including the identity of the remotely located user.

14. A deal management system of claim 12, wherein the matching module comprises a notifications and communications module for notifying to one of the plurality of first or second users when the sourcing engine matches a limited buy and limited sell specification.

15. A deal management system of claim 1, wherein the matching module comprises a notifications and communications module for notifying to one of the plurality of first or second users when the search engine matches a buy and sell specification.

16. A deal management system of claim 1, wherein the flow management module comprises a user management module arranged to enable a first or a second user to designate personnel who will be involved in the plurality of tasks associated with a specification acceptance process and the tasks of each of those personnel.

17. A deal management system of claim 3, wherein the flow management module comprises a user management module arranged to enable a first or a second user to designate personnel who will be involved in the plurality of tasks associated with a specification acceptance process and the tasks of each of those personnel and at least one of the data rooms to be assigned to the personnel.

18. A deal management system of claim 1, wherein the flow management module comprises a pipeline management module arranged to customize the specification acceptance process by enabling the first or second user to add, remove or edit tasks associated with the specification acceptance process.

19. A deal management system of claim 18, wherein the specification acceptance process comprises the stages of initial analysis, evaluation, negotiation and closing and the pipeline management module is arranged to specify which tasks each party wishes to assign to each stage of the specification acceptance process.

20. A deal management system of claim 19, wherein the pipeline management module is arranged classify each task as either individual or collaborative.

21. A deal management system of claim 20, wherein the pipeline management module is arranged prevent progress to the next stage until all of the collaborative tasks have been completed.

22. A deal management system of claim 21, wherein the transaction flow module is arranged to provide on the Graphical User Interface one or more matched buy and sell specifications, the progression of the specification acceptance process through the stages, the progression of tasks assigned to each stage and the personnel associated with each task.

23. A deal management system of claim 18, wherein the pipeline management module is arranged assign each task to specific personnel.

24. A deal management system of claim 18, wherein the pipeline management module is arranged assign a deadline to each task.

25. A deal management system of claim 1, wherein the flow management module comprises a communications module for establishing a communications channel between the first and the second user during the specification acceptance process.

26. A deal management system of claim 1, wherein system comprises an uploading module for uploading a pair of buy and sell specifications which have been matched offline, and the flow management module is arranged to carry out the specification acceptance process on the offline matched buy and sell specifications.

27. A method of managing a deal acceptance process, the method comprising:
storing in a plurality of sell specifications from a set of first users and a plurality of buy specifications from a plurality of second users, each of the sell specifications comprising a locked portion of data and a non-locked portion of data;
matching a search specification with one or more of the sell specifications, the matching step comprising:
searching the non-locked portions of the plurality of sell specifications,
sending an unlock request to a first user associated with a sell specification matched to the search specification, and
providing the locked portion of information of a matched sell specification to a second user associated with the matched searching specification in response to receiving an unlock permission from the first user; and
managing a plurality of tasks associated with a specification acceptance process, in response to a positive selection of a matched specification by a first user and a second user, providing a graphical user interface for managing the plurality of tasks until such time as the first and second users have accepted each other's buy and sell specifications and a deal regarding those specifications has been completed.
